(19) United States
(12) Patent Application Publication
(10) Pub. No.: US 2016/0075462 A1
(43) Pub. Date: Mar. 17, 2016

(54) TEST TUBE GRIPPER, TEST TUBE LABELING UNIT, AND TEST TUBE PREPARING APPARATUS INCLUDING THE SAME

(71) Applicant: ENERGIUM., LTD, Gyeonggi-do (KR)

(72) Inventors: Junghun Kang, Seoul (KR); Kanghee Lee, Seoul (KR); Sangjun Park, Gyeonggi-do (KR)

(73) Assignee: ENERGIUM., LTD, Gyeonggi-do (KR)

(21) Appl. No.: 14/784,563

(22) PCT Filed: Apr. 9, 2014
(86) PCT No.: PCT/KR2014/003071

§ 371 Date: Oct. 14, 2015

(30) Foreign Application Priority Data
Apr. 15, 2013 (KR) 10-2013-0041052
Apr. 15, 2013 (KR) 10-2013-0041054
Apr. 15, 2013 (KR) 10-2013-0041056

(51) Int. Cl. B65C 9/30; B25J 15/00; B01L 9/06

(52) U.S. Cl. CPC B65C 9/30; B01L 9/06; B25J 15/0028

(57) ABSTRACT

The present invention relates to a test tube preparation device which is compact, light and more mobile and improve the spatial layout of an installing unit, a transfer unit and a label attaching unit and the constitution of the units. According to an aspect, the invention may comprise a frame in which right and left installing units where a plurality of test tubes are vertically installed are provided on the upper part and at least one guide hole which allows the test tube to move by passing through the hole; a gripper transfer unit transfers the test tubes installed in the right and left installing units to the guide hole; a gripper pinches or separates the test tubes; and a labelling unit attaches a label to the waist of the test tube transferred through the guide hole.

### TECHNICAL FIELD

The present invention relates to a test tube gripper, a test tube labeling unit and a test tube preparation device including the test tube gripper and the test tube labeling unit. In particular, the present invention relates to: a test tube preparation device that attaches labels, containing various information items that hospitals, laboratories, universities, etc. require, to test tubes to provide the labeled test tubes; a test tube gripper that rapidly and accurately performs separation and movement of a test tube fitted into and aligned with a pallet; and a test tube labeling unit that introduces a test tube to the inside, changes the transfer direction and transfer position of the labeled test tube, and discharges the labeled test tube, via a swing discharge unit having a superior compatibility of installation with the peripheral transfer unit such as a clamp, a conveyor, etc., which are coupled to the labeling unit.

### BACKGROUND ART

Test tubes of which one end is sealed and the body is long in length and cylindrical in shape are used to store various types of samples such as, blood, animal tissue, plant tissue, chemicals, etc.

As test tubes are affixed with a label prescribing information about samples contained therein, their use increases the efficiency of work.

In particular, various fields, such as hospitals where a number of blood collection tubes (test tubes) are handled, have already employed an automatic labeling process, not relying on hand work.

In this regard, the applicant of the present invention has presented a test tube preparation device through the Korean Patent, Registration Patent No. 0,866,410.

The test tube preparation device of Korean Patent No. 0,866,410 is configured to include: a reception unit in which a plurality of test tubes are placed; a transfer unit, placed above the reception unit, for clamping or unclamping the test tubes in the reception unit, while moving in the X-Y plane and up and down; a label attaching unit, located below the transfer unit, for attaching a label around a test tube transferred and dropped from the transfer unit; and a discharge unit, located below the label attaching unit, for dropping down and discharging the test tube labeled by the label attaching unit.

Since the conventional test tube preparation device is configured in such a way that: the reception units have two-layered structure; and the transfer units, the label attaching unit and the discharge unit are located above the respective reception units, forming four layers in total, although the device is advantageous in that various types of test tubes can be efficiently labeled by a plurality of reception units and transfer units, it is disadvantageous in that it is large in size and heavy in weight, which deteriorates the mobility and the compatibility with the environment of installation or with users who use the test tubes.

In addition, since the conventional test tube preparation device is configured in such a way that every transfer unit corresponding to every reception unit of a multi-layer structure needs to be multi-layer in structure, the manufacturing cost is also increased, thereby deteriorating the productivity.

Test tubes are generally made of transparent glass or resin so that users can easily identify the contents.

In particular, various fields, such as hospitals where a number of blood collection tubes (test tubes) are handled, have already employed an automatic transfer system, not relying on hand work, thereby increasing the efficiency of work.

The test tube transfer system is configured in such a way that transfer units are placed in corresponding locations to transfer test tubes to corresponding areas, such as a test tube collecting unit, a washing unit, a labeling unit, a testing unit, a transfer conveyor, etc. The output end of the transfer unit is equipped with a gripper for gripping a test tube.

In general, the transfer unit may be equipped with one or more linear drivers, an articulated robot with multi-joints, etc.

As shown in FIG. 1, the test tubes 2 are stored and handled such that the lower part is inserted into the holes 11 of the pallet 10 shaped as an egg tray, so that they can be easily distributed and managed.

Each of the test tubes 2 is separated and moved from the holes 11 of the pallet 10 in such a way that: a gripper transfer unit transfers a gripper to the test tube 2; the gripper mechanically grips both sides of the test tube 2 by using the clampers (gripping arms); the gripper transfer unit moves up with the gripper for gripping the test tube 2; and the test tube 2 is separated from the hole 2 of the pallet 10.

Since the conventional test tube gripper configured as described above is equipped with only a driving unit that can hold or release both sides of a test tube with the clampers (gripping arms), it is advantageous in that its design is compact and simple. However, since the conventional gripper requires the gripper transfer unit to additionally include a moving-up unit for moving up and separating a test tube from the hole of the pallet, the transfer unit to which a gripper is installed is relatively complicated in structure and large in size. Since the gripping operation of the gripper and the moving up operation of the transfer unit are independently performed, controlling the transfer unit is also complicated. In particular, the gripping operation and the moving up operation are performed in serial, it takes relatively much time to separate and move one test tube. These are disadvantageous features of the conventional gripper.

In order to resolve these problems, the applicant of the present invention has presented a test tube preparation device through the Korean Patent, Registration Patent No. 0,866,410.

The gripper of Korean Patent No. 0,866,410 is configured to include: a gripper body; a finger fixing block for moving up and down with respect to the gripper body; an up-and-down operation unit for moving the finger fixing block up and down; a fixed finger, one end of which is fixed to the finger fixing block; and a movable finger, one end of which is pivotally coupled to the finger fixing block. The movable finger is elastically installed on the finger fixing block by a return spring, so that the movable finger keeps pressing upon the fixed finger. The gripper body includes, at the bottom part, a tilt guide contacting a protrusion support provided to the other end of the movable finger.

The conventional gripper configured as described above is operated in such a way that: when the fixed finger and movable finger are located at the lower end of the gripper body as the up-and-down operation unit operates, the fixed finger and movable finger are separated from each other so that the protrusion support of the movable finger is supported by the tilt guide and is received into the test tube; and the fixed finger and the movable finger are moved up, according to the operation of the up-and-down operation unit and simultaneously the protrusion support of the movable finger is separated from the tilt guide, so that the gripping operation for pressing the test tube can be implemented by the restoration force of the return spring.

However, it generally occurs that the test tube, the lower end of which is inserted into the hole of the pallet, does not generally keep the precise vertical posture, but is slightly inclined. This inclined state frequently occurs when the hole of the pallet is defective or the test tube is not correctly inserted into the hole of the pallet.

In a state where the test tube is obliquely placed in the hole of the pallet, the test tube and the finger collide with each other as the transfer unit advances the gripper to the test tube. When the test tube collides with the fixed finger fixed to the conventional finger fixing block, the test tube inserted into the hole of the pallet falls down. In this case, the test tube may be seriously damaged or cannot be processed by a gripping operation and a separation operation.

Although a test tube is oblique at a slight angle, the difference between the distance from the vertical axis to the test tube at the height of the lower end and the distance at the height of the higher end is large. Since the gripper of Korean Patent Registration No. 0,866,410 is configured in such a way that the finger advances to the lower end of the test tube, it enables the transfer unit to smoothly move, without collision, at the initial state.

However, as the devices operates, the finger moves up to the upper end of the test tube, and thus enters an area where the distance from the vertical axis is large. In this case, the finger may malfunction during the gripping operation.

In addition, in a state where the lower end of the test tube is tightly fitted into the hole of the pallet, when the finger for gripping the test tube is moved up by the gripper, the finger may slip from the test tube due to the strong frictional force between the test tube and the hole of the pallet, so that the test tube cannot be separated from the pallet.

In order to resolve the problem that the finger slips from the test tube, the finger may be designed to have a strong gripping force, such as the elastic coefficient of the return spring pressing the movable finger is set to a large value, etc. In this case, the strong gripping force may, however, cause the test tube to be distorted or broken.

As another method for implementing a strong gripping force in the finger, the distance between the fixed finger and the movable finger may be set to small. However, this method may also damage the test tube in the process of a strong gripping operation, and the finger may easily collide with the test tube due to the narrow space between the fixed finger and the movable finger while the finger is moving to the test tube by the transfer unit at the initial stage. To resolve these problems, other methods are required to implement an accurate control, such as attachment of a number of sensors, etc.

The applicant of the present invention has presented a test tube preparation device, as a type of test tube transfer system including the labeling unit described above, through the Korean Patent, Registration Patent No. 0,866,410.

The labeling unit of Korean Patent No. 0,866,410 is configured in such a way that: a frame is equipped with a stop space unit for receiving a test tube dropped and separated from a transfer unit; a driving roller is fixedly installed close around the test tube received by the stop space unit and rotates the test tube; one or more pressing rollers are placed opposite the driving roller with respect to the test tube and tightly presses the test tube against the driving roller; and an open-close cam is placed at the lower side of the stop space unit and drops down a labeled test tube.

The labeling unit configured as describe above is operated in such a way that: the stop space unit receives a test tube dropped from above; the pressing roller moves toward the driving roller to tightly fix the test tube between the driving roller and the pressing roller; and the driving roller is rotated to attach a label around the test tube. After that, the open-close cam opens the lower end to allow the labeled test tube to drop down, thereby discharging the labeled test tube.

The labeling unit of Korean Patent Registration No. 0,866,410 is configured to discharge a labeled test tube in a downward direction. To this end, the labeling unit needs to be designed so that the transfer units are stacked above and below the labeling unit; however, this design reduces the compatibility of installation.

Although the labeling unit of Korean Patent Registration No. 0,866,410 is modified to additionally include a side discharge unit for moving a labeled test tube in the sideways, the left and right sides of the insertion space of a test tube, in which a label attaching is performed, interfere with the driving unit for rotating the driving roller and the driving unit for pressing the pressing roller, respectively, and thus it is difficult to modify the structure for altering the direction of discharging the test tube.

### DISCLOSURE OF INVENTION

### Technical Problem

The present invention has been made in view of the above problems, and provides a test tube preparation device that is compact in design, light in weight and superior in mobility, as arrangement for a reception unit, a transfer unit, and label attaching units and their structures are improved.

The present invention further provides a test tube preparation device that can rapidly and accurately handle a test tube, such as attaching a label to the test tube, and gripping, transferring and discharging the test tube, etc., as arrangement for a reception unit, a transfer unit, a label attaching unit and a discharge unit and their structures are improved.

The present invention further provides a test tube preparation device that can rapidly and safely hold and separate a test tube, without malfunction, regardless of a posture state of the test tube, whether the test tube is oblique in the directions of the front, back, left and right, with respect to the reception unit or regardless of a posture with which the test tube is inserted into the reception unit.

The present invention further provides a test tube gripper that can rapidly and precisely separate and transfer a test tube inserted into a hole of a pallet from the hole.

The present invention further provides a test tube gripper that can rapidly and safely hold and separate a test tube, without malfunction, regardless of whether a posture state of the test tube is oblique in the directions of the front, back, left and right, with respect to the hole of the pallet or regardless of an orientation with which the test tube is inserted into a hole of the pallet.

The present invention further provides a labeling device with a swing discharge unit that enables the test tube transfer system to be variously altered in design, so that the labeling unit can: receive a test tube to be labeled, transferred from the outside; attach a label to the test tube without changing the position; rotate the test tube at a certain angle to change the position and direction; and discharge the test tube.

### Solution to Problem

In accordance with an embodiment of the present invention, the present invention provides a test tube preparation device including: a frame (100) configure in such a way that: left and right reception units (110A and 110B) receiving a plurality of test tubes (2) in vertical state are formed on the upper side and one or more guide holes (115) through which the test tubes (2) pass are formed between the left and right reception units (110A and 110B); a gripper transfer unit (200), installed to the frame (100), for transferring the test tubes (2) received in the left and right reception units (110A and 110B) to the guide holes (115); a gripper (300) coupled to the gripper transfer unit (200), for gripping or separating the test tubes (2); and a labeling unit (400), arranged under the guide holes (115), for attaching labels to the outer surface of the test tubes (2) transferred passing through the guide holes (115).

Preferably, the frame (100) is configured in such a way that the upper frame (110) to which the gripper transfer unit (200) is installed and a lower frame (150) to which the labeling unit (400) is installed are arranged in layer.

Preferably, the test tube preparation device further may include a loading unit (120) for blocking the guide holes (115) to make the introduced test tubes (2) to be in a waiting state.

Preferably, the gripper transfer unit (200) includes: a left-right transfer unit (210) with a gantry block (214) of which the front-read ends are coupled to move in the left-right direction with respect to the frame (100); a front-back transfer unit (230) with a front-back moving block (232) that is coupled to move in the front-back direction with respect to the gantry block (214); and a rotation transfer unit (250) with a base plate (254) that is coupled to rotate with respect to the front-back moving block (232). The gripper transfer unit (200) transfers the gripper (300) coupled to the base plate (254) in the left-right direction (X) and front-back direction (Y) with respect to the left and right reception units (110A and 110B), and rotates the gripper (300) to face the left and right reception units (110A and 110B).

Preferably, the rotation transfer unit (250) may be configured to reciprocate and rotate between the left and right reception units (110A and 110B).

In accordance with another embodiment of the present invention, the present invention provides a test tube gripper that grips a test tube (2) of which the lower portion is inserted into a hole (11) of a pallet (10), separates the test tube (2) from the pallet (10) and transfers the test tube (2), the gripper (300) including: a base plate (254); a gripper body (330) coupled to the base plate (254); a finger fixing block (340) for moving up and down with respect to the gripper body (330); an up-and-down operation unit (350) for moving the finger fixing block (340) up and down; and a finger (360) configured: to be coupled to the finger fixing block (340); to move up and down cooperating with the finger fixing block (340); to allow the clampers facing each other to be apart from each other to receive the test tube 2 when moving down; and to allow the clampers facing each other to move close to each other to grip the received test tube 2 when moving up. The gripper body (330) is rotated in the front-back direction (Y′) with respect to the base plate (310) by a front-back direction (Y′) repulsive force of the test tube (2) created during the gripping and separating processes of the test tube (2); and the finger (360) is rotated in the left-right direction (X′) with respect to the finger fixing block (340) by a left-right direction (X′) repulsive force of the test tube (2) created during the gripping and separating processes of the test tube (2).

Preferably, the gripper may further include: a first return spring (325) that connects the gripper body (330) and the base plate (310) and presses the gripper body (330) in the front direction to rotate the gripper body (330) about the rotational shaft.

Preferably, the finger (360) may include: a first finger (370) including: a first fixing piece (371) coupled to the finger fixing block (340); and a first gripping part (373) formed to be extended from the first fixing piece (371); a second finger (380) including: a second fixing piece (381) rotatably coupled to the finger fixing block (340); and a second gripping part (383) formed to be extended from the second fixing piece (381), facing the first gripping part (373); and a second return spring (390) for connecting the first finger (370) and the second finger (380) and pressing the first gripping part (373) and the second gripping part (383) to approach each other.

Preferably, the gripper body (330) may form a gripping cooperation guide (3325) including a slant guide unit (3328) that: contacts a protrusion support (387) formed in the second fixing piece (381) and separates the second gripping part (383) from the first gripping part (373) when the first and second fingers (370 and 380) are maximally moved down; and moves gradually close the second gripping part (383) to the first gripping part (373) when the first and second fingers (370 and 380) move up.

Preferably, the first fixing piece (371) may be coupled to rotate and move in the left-right direction from the finger fixing block (340).

Preferably, the first fixing piece (371) coupled to the finger fixing block (340) may include, on the outer surface, first and second support surfaces (3710 and 3712) for restricting the rotation and movement in the left-right direction of the first finger (370).

Preferably, the gripper body (330) may include: an upper fixing part (331) coupled to the base plate (310); a lower fixing part (333), downward apart from the upper fixing part (331), for limiting the downward movement of the finger (360); and a connection housing (332) coupling the upper fixing part (331) and the lower fixing part (333) to each other and guiding the up-and-down movement of the finger fixing block (340). The gripper may further include: a test tube height sensing sensor for sending a height of the test tube that the finger (360) grips and separates from the hole (11) of the pallet (10).

In accordance with an embodiment of the present invention, the present invention provides a test tube labeling unit may include: a frame (410) with a holding member (420) supporting a test tube (2) introduced to the inside; a drive roller (430), arranged at one end around the test tube (2), for providing a rotational force to the test tube (2) to perform a label attachment; and a pressure roller (440), arranged opposite the drive roller (430), with respect to the test tube (2), for performing the contact or separation of the test tube (2) to or from the drive roller (430). The holding member (420) is rotated in an interval between the first position (P1) from which the test tube (2) is introduced to the inside and the second position (P2) from which the test tube (2) is discharged to the outside.

Preferably, the holding member (420) may be rotated from the first position (P1) to the second position (P2) to be protruded outward from the inside of the frame (410).

Preferably, the holding member (420) may include: an upper inflow opening (421) introducing the test tube (2) to the inside; a lower stopper (422) for supporting the lower end of the test tube (2); and a side stopper (423) for coupling the upper inflow opening (421) and the lower stopper (422) to each other, wherein the side stopper (423) forms, at one side, a side opening (4230) for allowing the separation of the test tube (2).

Preferably, the frame (410) comprises a pusher (470) inserted into the holding member (420) rotating to the second position (P2); and the pusher (470) is inserted to the holding member (420) when the holding member (420) is rotated to the second position (P2) to push the test tube (2) so that the test tube (2) is separated through the side opening (4230).

Preferably, the test tube labeling unit may further include: a test tube insertion depth adjusting device with a mobile stopper (460) for supporting the lower end of the test tube (2) inserted into the holding member (420).

Preferably, it is preferable that the test tube (2) includes three or more supporting points on the outer surface by one drive roller (430) and two or more pressure rollers (440).

Preferably, the pressure roller (440) may include: a fixed pressure roller (441) fixedly installed to the frame (410); and a mobile pressure roller (443) connected to the frame (410) to move close to or apart from the center of rotation of the test tube (2).

Preferably, the test tube labeling unit may include a pivoting member (445) of which: the middle portion is coupled to the frame (410) with the hinge (4451); one end is coupled to the mobile pressure roller (443) so that the end can be rotated about the hinge (4451); and the other end is coupled to an operating cylinder (446).

### Advantageous Effects of Invention

The present invention improves the arrangement so that a reception unit, a transfer unit, a label attaching unit and a discharging unit are intensively arranged in two-layered frame structure, and thus the test tube preparation device is compact in overall size, light in weight and superior in mobility, and has a superior compatibility of installation to the peripheral environment.

The present invention optimally distributes work time to every unit for one test tube and excludes an unnecessary driving environment, thereby increasing the work efficiency with rapidness and accuracy.

The present invention can rapidly and safely hold and separate test tubes without malfunction, although the test tubes are not correctly received in the reception unit or the test tubes are tightly placed in the reception unit, thereby increasing the transfer efficiency of the test tubes.

The present invention can rapidly and safely hold and separate test tubes without malfunction, although the lower parts of the test tubes are not correctly inserted into holes of a pallet or the lower parts of the test tubes are tightly fitted into holes of a pallet with a strong frictional force, thereby increasing the transfer efficiency of the test tubes.

The present invention: receives a test tube at a first position; attaches a label to the test tube at the first position; rotates the test tube at the first position at a certain angle to change the position and direction; and discharges the test tube, thereby providing a superior compatibility of installation to the peripheral transfer unit.

### BRIEF DESCRIPTION OF DRAWINGS

FIGS. 1A and 1B are perspective views of a test tube preparation device;

FIGS. 2A and 2B are perspective views of a test tube preparation device when the cover is open;

FIG. 3 is a perspective view of a test tube preparation device when the cover is removed;

FIGS. 4A and 4B are a perspective view and a top view of an upper frame, respectively;

FIGS. 5A and 5B are top view showing the configuration and operations of a loading unit according to an embodiment of the present invention;

FIG. 6 is a perspective view showing the configuration of a loading unit and a guiding hole according to another embodiment of the present invention;

FIGS. 7A and 7B are top views showing the configuration and operations of a loading unit according to another embodiment of the present invention;

FIGS. 8 to 10 are perspective views showing the configurations and operations of a gripper transfer unit;

FIG. 11 is an exploded perspective view showing the configurations of the gripper;

FIG. 12 is a side view of a gripper, showing the operation of the titling rotational shaft;

FIG. 13 is a perspective view and a partially cut perspective view of a coupling housing;

FIG. 14 is a cross-sectional view showing a coupling structure of a finger fixing block and a coupling housing;

FIG. 15 is a perspective view showing a coupling structure and a configuration of a finger and a finger fixing block;

FIGS. 16A to 16C are views showing the structure of a gripper seen in various directions when a finger moves down and is located at the lower position;

FIGS. 17A to 17C are views showing the structure of a gripper seen in various directions when a finger moves up and is located at the upper position;

FIG. 18 is a cross-sectional view showing a coupling structure of a first finger and a finger fixing block;

FIG. 19A is a cross-sectional view to show the gripping operation of a finger, taken along line C-C shown in FIG. 16A, and FIG. 19B is a cross-sectional view to show the gripping operation of a finger, taken along line D-D shown in FIG. 176A;

FIG. 20 is a concept view describing a repulsive force transferable from a test tube when the test tube is gripped;

FIG. 21 is a perspective view showing the configuration of a labeling unit;

FIG. 22 is a top view showing the configuration of a label providing device;

FIG. 23 is a front perspective view of a labeling unit;

FIG. 24 is a rear perspective view of a labeling unit;

FIG. 25 is a front perspective view of a labeling unit when the front frame is separated;

FIG. 26 is an exploded perspective view showing the configuration of the labeling unit;

FIGS. 27A to 27C are views showing the structure of a holding member seen in various directions;

FIG. 28A is an exploded perspective view showing the configuration of a test tube insertion depth adjusting unit and FIG. 28B is an view showing the operation of the test tube insertion depth adjusting unit;

FIG. 29 is a front view showing a driving roller and a pressing roller;

FIG. 30 is a cross-sectional view, taken along line A-A shown in FIG. 29;

FIG. 31 is a top view showing the label attaching operation by a driving roller and a pressing roller;

FIG. 32 is a view showing a state where a test tube moves into the labeling unit; and

FIG. 33 is a view showing a state where a test tube is discharged from the labeling unit.

### MODE FOR THE INVENTION

The features and advantages of embodiments of the present invention will become more apparent from the following detailed description in conjunction with the accompanying drawings.

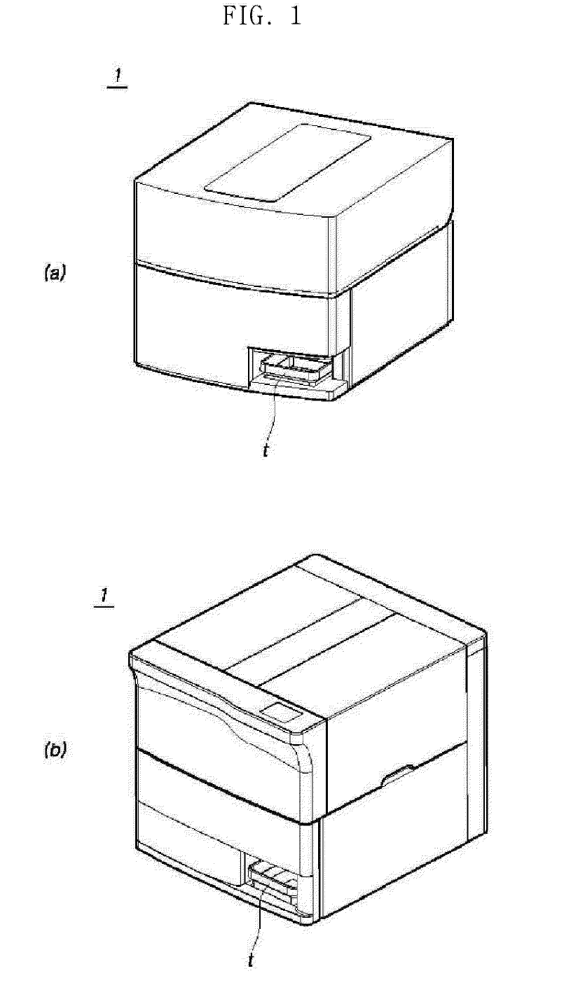

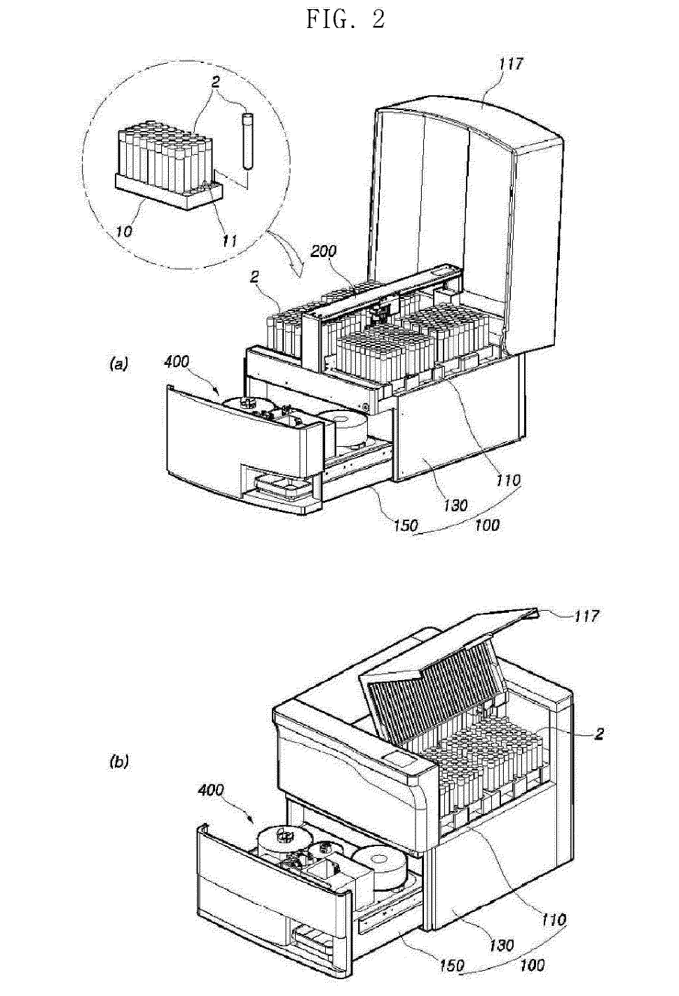

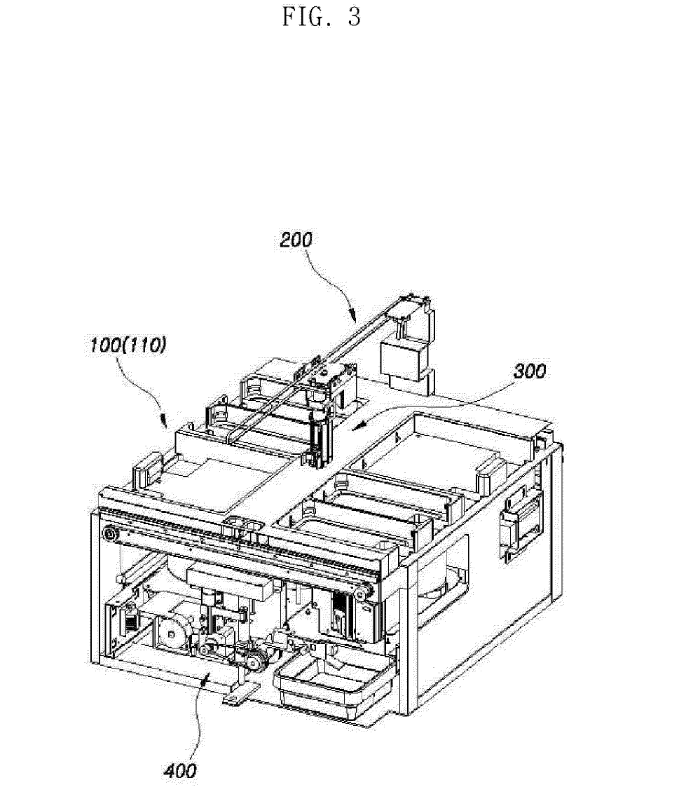

FIGS. 1A and 1B are perspective views of a test tube preparation device. FIGS. 2A and 2B are perspective views of a test tube preparation device when the cover is open. FIG. 3 is a perspective view of a test tube preparation device when the cover is removed.

The test tube preparation device 1 includes a frame 100, a gripper transfer unit 200, a gripper 300, and a labeling unit 400.

The frame 100 refers to a member for supporting test tubes 2 and respective units forming the test tube preparation device. The frame 100 includes an upper frame 110, a supporting frame 130 and a lower frame 150.

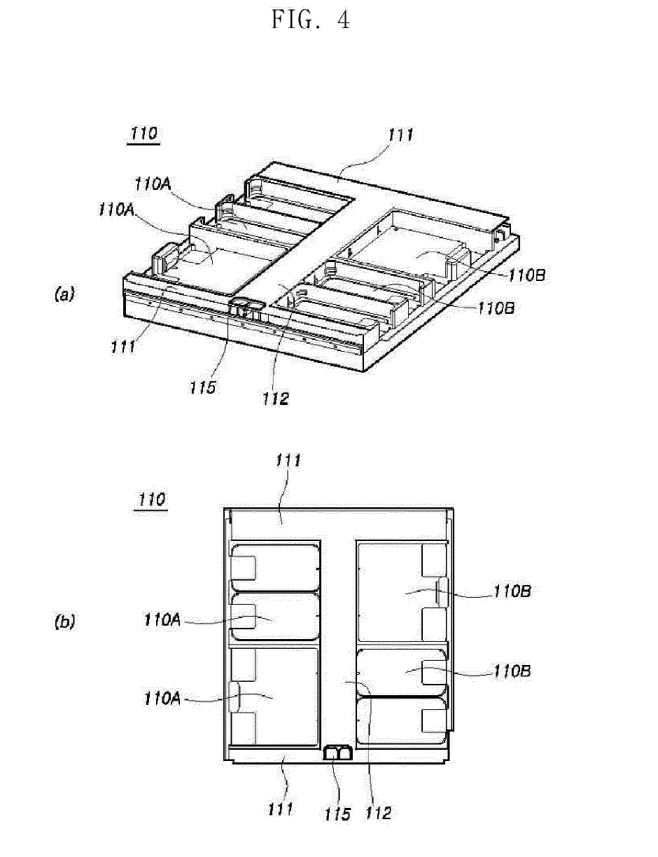

Referring to FIGS. 4A and 4B, the upper frame 110 includes a left reception unit 110A and a right reception unit 110B on which a plurality of test tubes 2 are received. The left and right reception units 110A and 110B provide compartments for receiving one or more pallets 10 each of which a plurality of test tubes 2 are vertically pre-fitted into. The left and right reception units 110A and 110B may receive test tubes 2 that are of the same type or different type from each other.

The upper frame 110 forms one or more guide holes 115 for moving down test tubes 2 transferred by the gripper 300 and the gripper transfer unit 200. The guide hole 115 is arranged at the center of the upper frame 110 that the left and right reception units 110A and 110B are opposite each other.

In the embodiment, the upper frame 110 includes front and back frames 111 and a center frame 112 connecting the middles of the front and back frames 111 to each other. From this arrangement, the left and right reception units 110A and 110B are arranged at both sides of the center frame 112. Therefore, the center frame 112 forms one or more guide holes 115 for receiving test tubes 2 and moving them down. The guide holes 115 may be formed at any position on the center frame 112 along the lengthwise direction; however, it is preferable that they may be formed at one end at the front side as shown in FIGS. 4A and 4B.

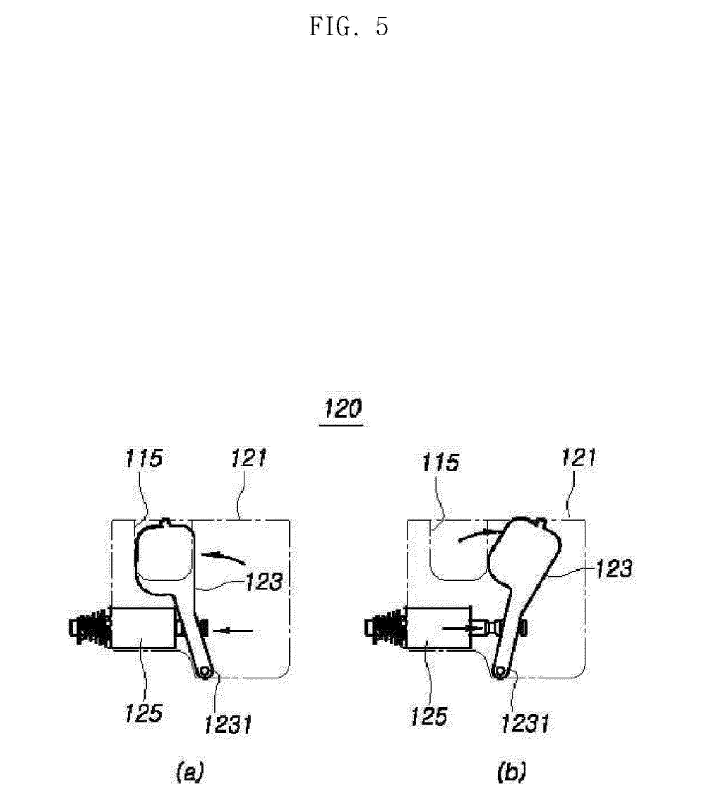

Referring to FIGS. 5A and 5B, the guide hole 115 may be equipped with a loading unit 120 in which a test tube 2, transferred by the gripper 300 and the gripper transfer unit 200, is placed, where the loading unit 120 grips the test tube and waits for a while. That is, by way of precaution against a case that the labeling unit 400, located below the loading unit 120, is labeling the transferred test tube 2 or is not readied to operate due to maintenance or repair, the loading unit 120 temporarily prevents the test tube 2 transferred by the gripper 300 and the gripper transfer unit 200 from dropping down through the guide hole 115.

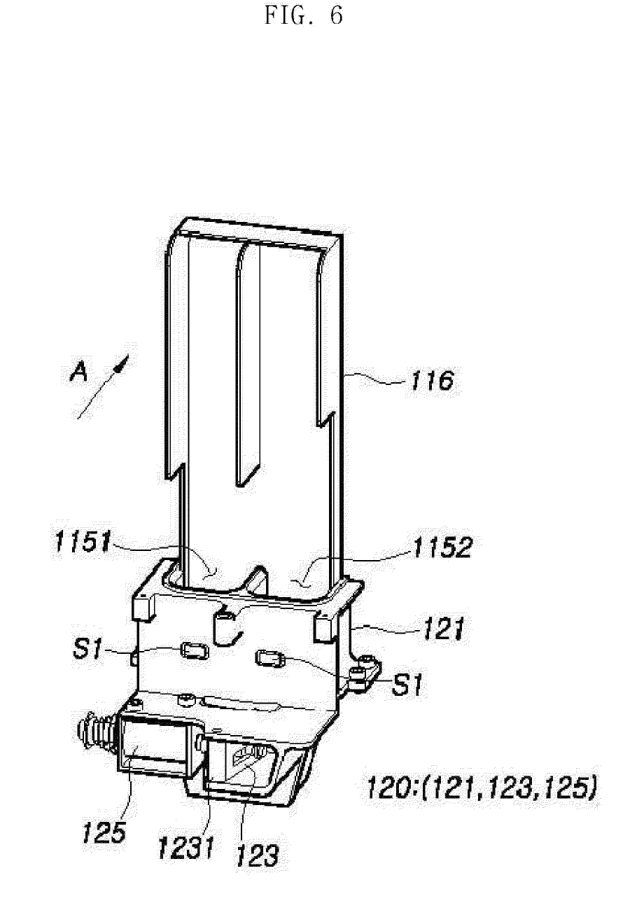

Referring to FIG. 6, the loading unit 120 according to the embodiment includes a guide hole member 121, a block plate 123 and a loading operation unit 125.

The guide hole member 121 refers to a member forming a guide hole 115, and is coupled to one end of the front of the center frame 112.

The block plate 123 is a member for opening or closing the guide hole 115. One end of the block plate 123 is coupled to a hinge 1231 of the guide hole member 121 so that the block plate 123 pivotally rotates and move with respect to the hinge 1231 in the side direction of the guide hole 115. The block plate 123 rotates and moves with respect to the hinge 1231 to open or close the guide hole 1115 formed in the guide hole member 121.

The loading operation unit 125 provides a driving force so that the block plate 123 can rotate and move with respect to the hinge 1231. The loading operation unit 125 is installed to the guide hole member 121 to be coupled to the block plate 123. The loading operation unit 125 may be implemented with a cylinder, an electric motor, or the like.

As the loading operation unit 125 operates to extend or reduce the length, the block plate 123 moves and rotates with respect to the hinge 1231 to: close the guide hole 115, so that the test tube 2, transferred by the gripper 300 and the gripper transfer unit 200 and placed on the guide hole 115, is fixed as the bottom is supported by the block plate 123; or to open the guide hole 115 so that the test tube 2 drops down through the guide hole 115.

The guide hole member 121 may form two or more guide holes 1115.

Referring back to FIGS. 4A and 4B, the guide hole member 121 is implemented to form, for example, two guide holes 1115. While the test tube preparation device transfers the test tubes 2, received in the left and right reception units 110A and 110B, to the two guide holes 115, by using the gripper 300 and the gripper transfer unit 200, at the initial operation, one of the two test tubes 2 is previously placed in one of the two guide holes 115 manually (i.e., by the user). With the initial transfer operation of the test tubes 2 by the gripper 300 and the gripper transfer unit 200, the labeling unit 400 may previously perform a labeling process for the test tube 2 placed previously manually. After that, the labeling unit 400 continues to sequentially label the test tubes 2 transferred by the gripper 300 and the gripper transfer unit 200.

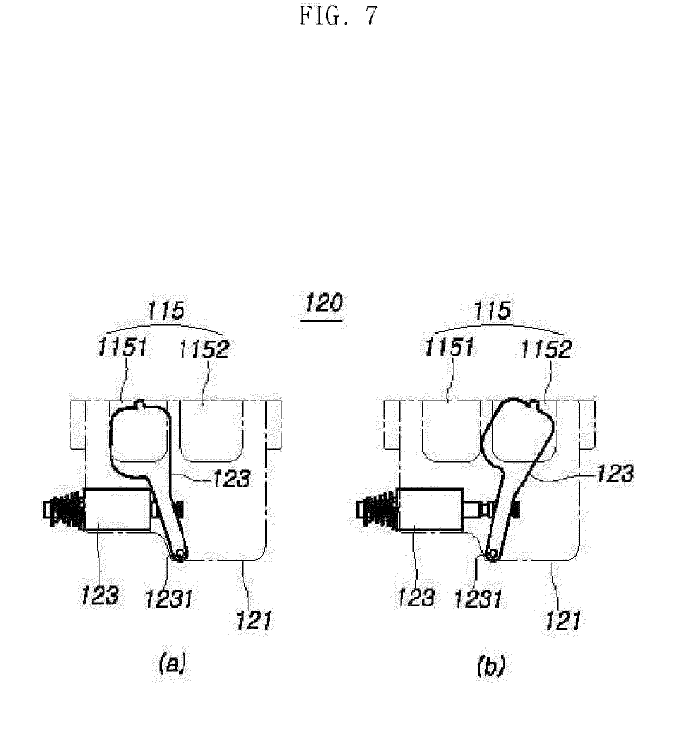

The test tube preparation device according to the present invention labels one test tube 2 by using the labeling unit 400 for a shorter period of time than that taken to transfer the test tubes 2, received in the left and right reception units 110A and 110B, to the guide holes 115 by using the gripper 300 and the gripper transfer unit 200. Therefore, although the guide hole member 121 is implemented with one guide hole 1115 as shown in FIGS. 5A and 5B, the test tube preparation device according to the present invention does not cause a transfer accumulation of test tubes 2. However, when the test tube preparation device labels a test tube 2 by using the labeling unit 400 for a longer period of time than that taken to transfer the test tubes 2, received in the left and right reception units 110A and 110B, to the guide holes 115 by using the gripper 300 and the gripper transfer unit 200, the guide hole member 121 is implemented to form two or more guide holes 1115 as shown in FIGS. 6 and 7A and 7B, so that the transfer of test tubes by the gripper 300 and the gripper transfer unit 200 can be prevented from being stopped intermittently and the labeling unit 400 can also continue to perform the labeling process without interruption.

FIG. 6 is a perspective view showing the configuration and operations of a loading unit, and FIGS. 7A and 7B are top views showing the configuration and operations of a loading unit, when the guide holes are two, according to another embodiment of the present invention.

Although the guide hole member 121 is implemented to form two guide holes 115, i.e., first guide hole 1151 and second guide hole 1152, the loading unit 120 may be implemented as the embodiment shown in FIG. 6. That is, the loading unit 120 is configured to include a guide hole member 121, a block plate 123 and a loading operation unit 125. The detailed description about the same parts described above is omitted. Reference number S1 refers to a sensor for sensing whether test tubes 2 are placed in the first and second guide holes 1151 and 1152. Reference number 116 refers to a guider that guides test tubes 2, transferred in direction A by the gripper 300 and the gripper transfer unit 200, to vertically drop down and to be inserted into the guide hole 115 without tilting when the test tubes are finally separated from the gripper 300.

Referring to FIGS. 7A and 7B, when the guide hole member 121 is implemented to form first and second guide holes 1151 and 1152, the block plate 123 rotates and moves between the first and second guide holes 1151 and 1152 with respect to the hinge 1231, as the loading operation unit 125 operates to extend or reduce the length. That is, as shown in FIG. 7A, as the loading operation unit 125 operates to reduce the length, the block plate 123 closes the first guide hole 1151 and opens the second guide hole 1152. In contrast, as shown in FIG. 7B, as the loading operation unit 125 operates to extend the length, the block plate 123 opens the first guide hole 1151 and closes the second guide hole 1152.

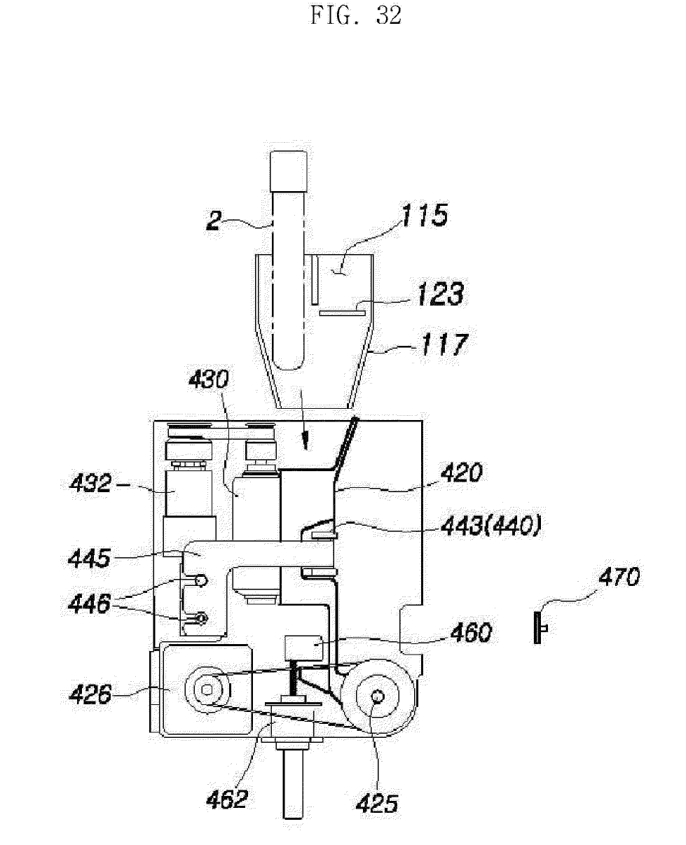

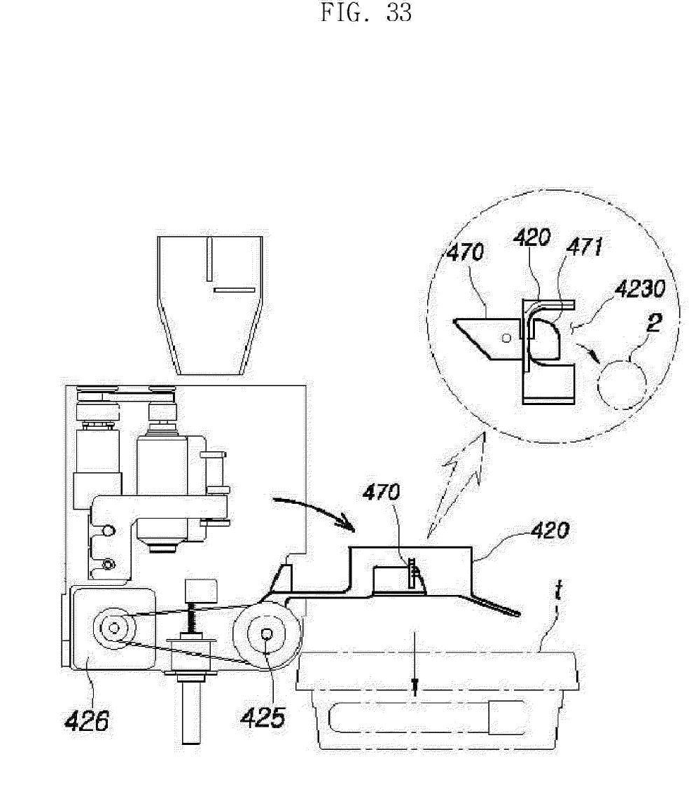

Therefore, the gripper 300 and the gripper transfer unit 200 may alternatively transfer a test tube 2 to the first and second guide holes 1151 and 1152. The gripper 300 and the gripper transfer unit 200 may also continue transferring test tubes 2 to only one of the first and second guide holes 1151 and 1152. When the guide hole member 121 is implemented to form two or more guide holes 115, each of the guide hole 115 includes, at the lower side, a tilt guide 117 the diameter of which is reduced as it goes down, so that, although test tubes 2 are placed into any guide holes 115, the tilt guides 117 of the guide holes 115 can precisely guide the test tubes 2 to drop down to the labeling unit 400 as shown in FIGS. 32 and 33.

Meanwhile, as shown in FIGS. 1A and 1B and 2A and 2B, the upper frame 110 may further include a cover 117 for opening or closing the frame. While the test tube preparation device is operating, the cover 117: isolates the test tubes 2 in the left and right reception units 110A and 110B from the outside to keep the test tubes 2 and the transfer unit 200 that will be described later clean; and prevents the test tubes from getting out of the positions in place or the transfer unit 200 from malfunctioning, when the cover 117 happens to open carelessly. The cover 117 may be preferably made of a transparent material to identify the inside in a closed state. As shown in FIGS. 1A and 2A, the cover 117 simultaneously may close or open the left and right reception units 110A and 110B. As shown in FIGS. 1B and 2B, the device may include covers 117 to cover the left and right reception units 110A and 110B independently, respectively. Although it is not shown, the cover 117 may also be implemented in a pivotal type (movement and rotation type) or a slide type.

The supporting frame 130 refers to a member for supporting the upper frame 110 at a certain height from the bottom. The supporting frames 130 may be coupled to each other, thereby forming a side cover.

The lower frame 150 refers to a member for providing a space to which a test tube 2 flowing down from the guide hole 115 of the upper frame 110 is move. The lower frame 150 installs the labeling unit 400 thereon. The lower frame 150 includes a tray t on which the labeled test tube 2 is placed at the one open side. In addition, the lower frame 150 according to the embodiment is implemented in a slide type, as a drawer, for opening or closing with respect to the supporting frame 130. This slide type of lower frame 150 makes it easy to replace the label papers of the labeling unit 400 installed in the inside and to perform maintenance and repair of the labeling unit 400. Since the slide type structure is well-known, its detailed description is omitted below.

As described above, since the present invention is configured in two-layer structure in such a way that the left and right reception units 110A and 110B, the gripper 300 and the gripper transfer unit 200 are arranged above the upper frame 110 forming guide holes 115 and the labeling unit 400 and the discharge unit are arranged below the upper frame 110 forming guide holes 115, it is compact in entire design and has convenience in installation and mobility in a relatively small user space, such as hospital, laboratory, office, etc., compared with the conventional system disclosed on Korean Patent Registration No. 0,866,410.

The following description is provided about the shapes of the gripper transfer unit 200, gripper 300 and labeling unit 400 to meet the compact test tube preparation device.

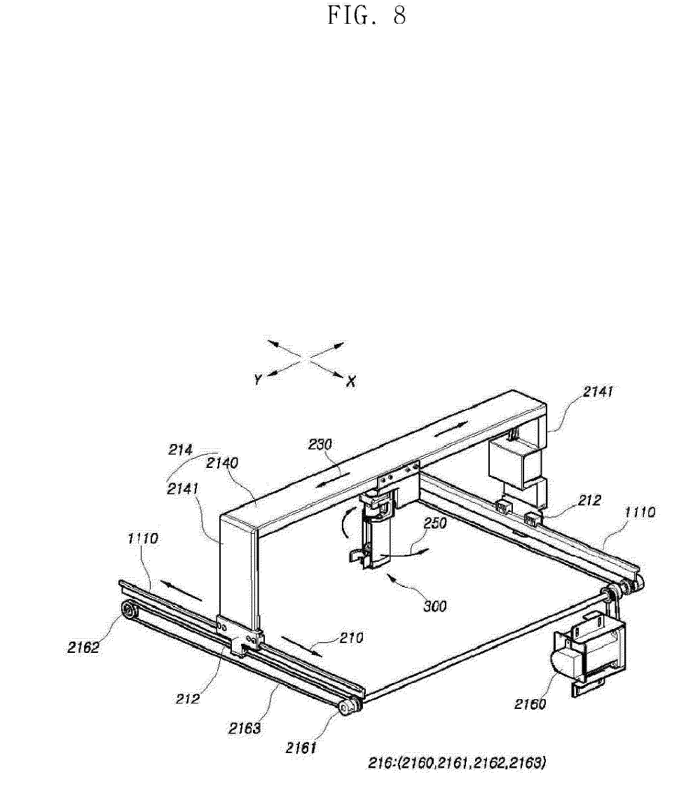

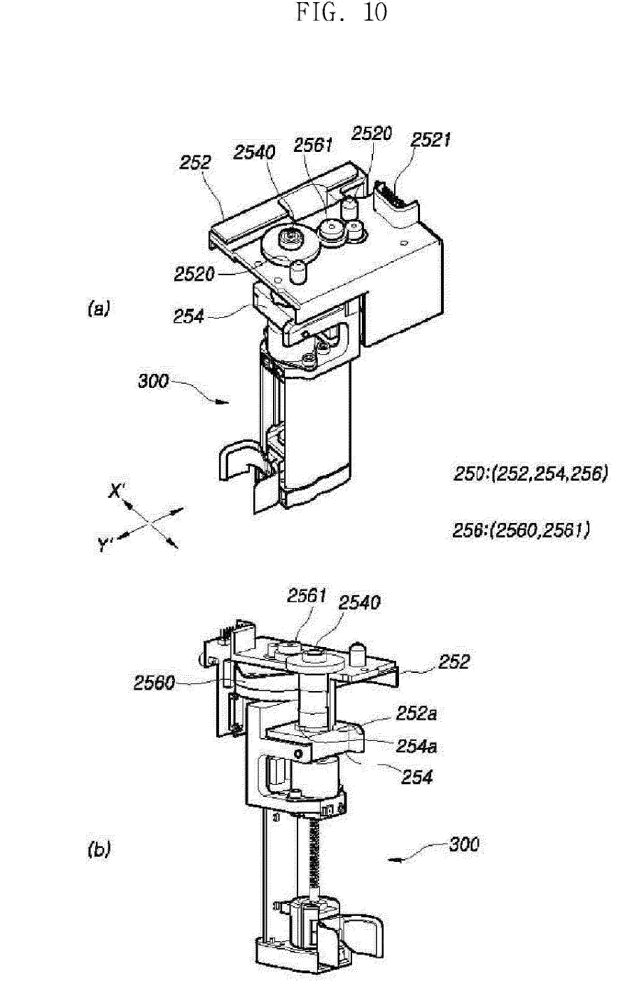

FIGS. 8 to 10 are perspective views showing the configurations and operations of a gripper transfer unit.

The gripper transfer unit 200 is installed above the upper frame 110, and transfers test tubes 2 received in the left and right reception units 110A and 110B of the upper frame 110 to the guide holes 115 of the upper frame 110. That is, the gripper transfer unit 200 transfers: the gripper 300 to the test tubes 2 received in the left and right reception units 110A and 110B; or the gripper 300 gripping the test tubes 2 to the guide holes 115 of the upper frame 110.

To this end, the gripper transfer unit 200 includes a left-right transfer unit 210, a front-back transfer unit 230 and a rotation transfer unit 250.

The left-right transfer unit 210 moves the gripper 300 in the left and right directions of the upper frame 110. The left-right transfer unit 210 includes a left-right moving block 212, a gantry block 214, and a left-right operating block 216.

The left-right moving block 212 is coupled to the front and back frames 111 of the upper frame 110 to slidably move in the left and right directions. The sliding surfaces of the left-right moving block 212 and the front and back frames 111 form rail coupling structures.

The gantry block 214 refers to gantries that are coupled to the left-right moving block 212 and cooperates with the left-right moving block 212. The gantry block 214 includes a horizontal bar 2140 with a length in the front-back direction of the upper frame 110 and front and back supports 2142 for supporting both ends of the horizontal bar 2140. The lower ends of the front and back supports 2142 are coupled to the left-right moving block 212, respectively.

The left-right moving block 212 and the front and back supports 2142 of the gantry block 214 are coupled to each other with couplers so that they can be easily coupled to and uncoupled from each other. This structure is to easily perform maintenance and repair, such as replacement, etc., for the gantry block 214, and the gripper 300, the rotation transfer unit 250 and the front-back transfer unit 230 installed above the gantry block 214.

The left-right operating block 216 provides driving force to the left-right moving block 212 in the left and right directions. Referring to FIG. 8, the left-right operating block 216 according to the embodiment is configured in such a way that: the driving shaft 2161 and the following shaft 2162 are installed to the both ends of the front and back frames 111 of the upper frame 110, spaced apart from each other; the driving shaft 2161 and the following shaft 2162 are coupled to each other with a pulley and a belt 2163; and the lower end of the left-right moving block 212 is fixed onto the belt 2163. Therefore, as the left-right driving motor 2160 coupled to the driving shaft 2161 rotates in the forward or reverse direction, the gantry block 214 reciprocates above the front and real frames 111 in the left and right directions of the upper frame 110. The motive power transmission by the pulley and belt may be implemented with a sprocket and chain, a bolt screw and nut block, a rack and pinion, etc.

Referring to FIG. 8, reference number 1110 refers to guide rails that are provided to the front and back frames 111 and coupled to the left-right moving block 212 to guide the block 212 in the left and right directions.

The front-back transfer unit 230 moves the gripper 300 in the front and back directions of the upper frame 110. The front-back transfer unit 230 includes a front-back moving block 232 and a front-back operating unit 234.

The front-back moving block 232 is coupled to the horizontal bar 2140 of the gantry block 214 to slidably move in the front and back directions. The sliding surfaces of the upper side of the front-back moving block 232 and the lower side of the horizontal bar 2140 form rail coupling structures.

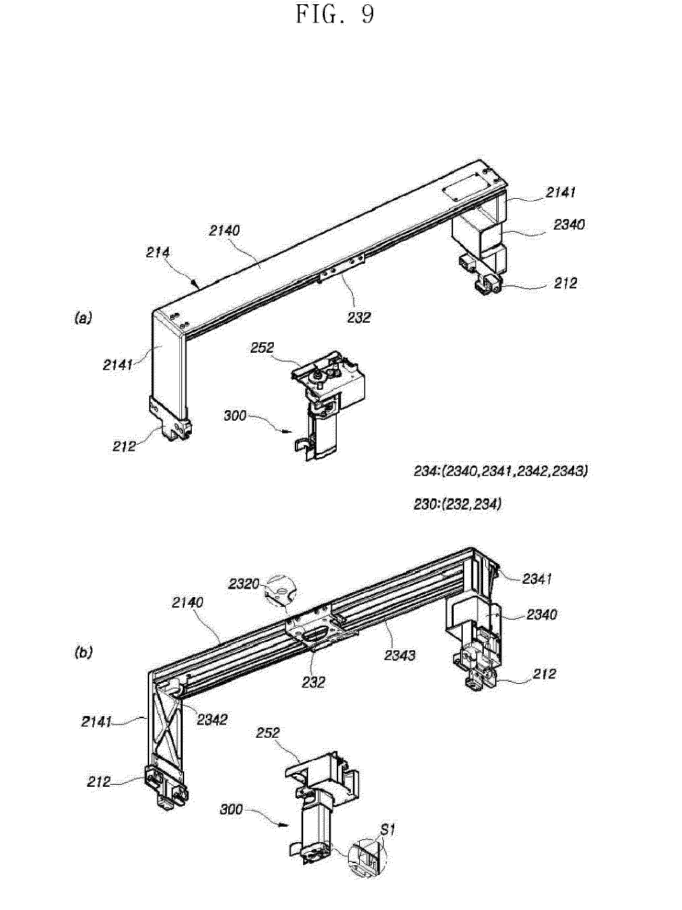

The front-back operating unit 234 provides driving force to the front-back moving block 232 in the front and back directions. Referring to FIGS. 9A and 9B, the front-back operating unit 234 according to the embodiment is configured in such a way that: the driving shaft 2341 and the following shaft 2342 are installed to the both ends of the horizontal bar 2140 of the gantry block 214; the driving shaft 2341 and the following shaft 2342 are coupled to each other with a pulley and a belt 2343; and the front-back moving block 232 is fixed onto the belt 2343. Therefore, as the front-back driving motor 2340 coupled to the driving shaft 2341 rotates in the forward or reverse direction, the front-back moving block 232 reciprocates above the horizontal bar 2140 of the gantry block 214 in the front and back directions.

The rotation transfer unit 250 rotates the gripper 300 so that the gripper 300 can face the left reception unit 110A or right reception unit 110B. The rotation transfer unit 250 includes a fixed support block 252, a gripper base plate 254 and a rotation driving unit 256.

The fixed support block 252 is fixedly coupled to the front-back moving block 232, cooperating with the front-back moving block 232.

The front-back moving block 232 and the fixed support block 252 are coupled to each other with a coupler so that they can easily be coupled to and uncoupled from each other. This structure is to easily perform maintenance and repair, such as replacement, etc., for the gripper 300 and the rotation driving unit 256 installed to the fixed support block 252. In particular, the fixed support block 252 forms, on the upper surface, a connector protrusion 2520 inserted into a connector hole 2320 formed on the lower surface of the front-back moving block 232, so that, when coupling the fixed support block 252 to the front-back moving block 232, the connector protrusion 2520 can be smoothly inserted into the connector hole 2320, and thus the electrical connector 2521 of the fixed support block 252 can make rapid and precise connection and can remain in the assembling position.

The gripper base plate 254 is a member for supporting the gripper 300 that will be described later. The gripper base plate 254 is rotatably coupled to the fixed support block 252. That is, the gripper base plate 254 is coupled to the fixed support block 252 with the rotation shaft 2540 aligned vertically from the lower side of the fixed support block 252.

The gripper base plate 254 may be configured in such a way as to continue to rotate, with respect to the fixed support block 252, about the rotation shaft 2540 in the forward or reverse direction. However, it is preferable that the gripper base plate 254 is configured in such a way as to reciprocate and rotate within 180° between the left and right reception units 110A and 110B. That is, it is preferable to set the rotation angle of the gripper base plate 254 to range 90° from the front of the upper frame 110 (0° facing the guide hole) in both the left and right directions, respectively. To this end, the fixed support block 252 includes a stopper 252a at the one end, and the gripper base plate 254 forms a protruded part 254a limiting the maximum rotation angle.

The rotation driving unit 256 provides a rotational force of the gripper base plate 254. The rotation driving unit 256 according to the embodiment couples the rotational driving motor 2560 installed to the fixed support block 252 to the rotation shaft 2540 of the gripper base plate 254 with a group of reduction gears 2561.

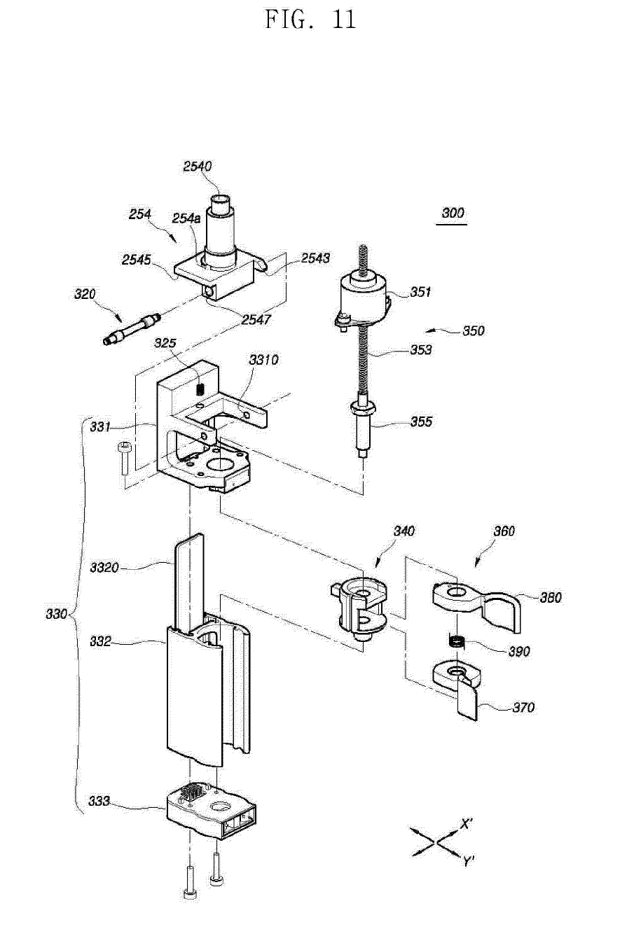

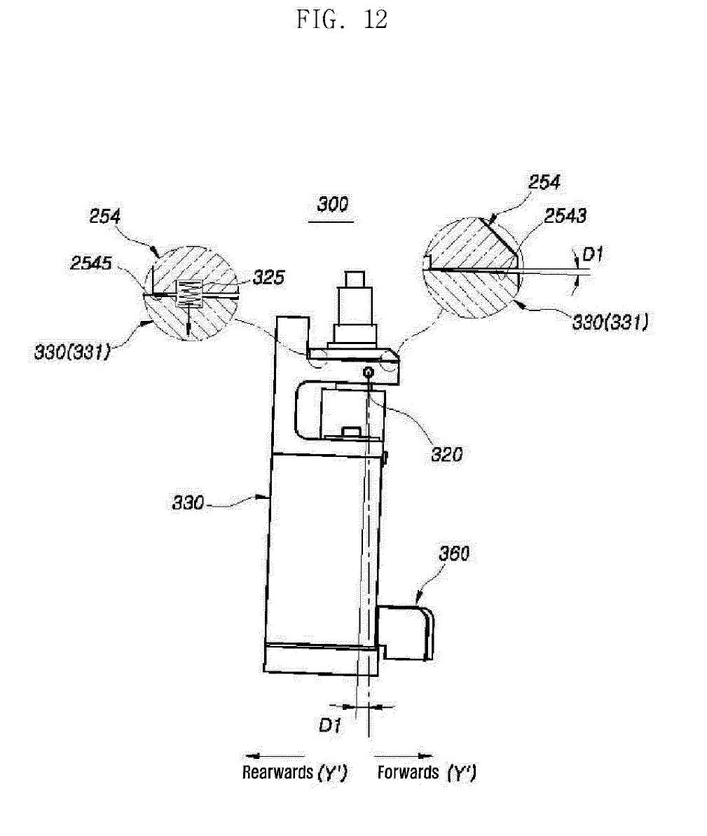

FIGS. 11 and 12 are an exploded perspective view and a side view of a gripper.

Referring to FIGS. 11 and 12, the gripper 300 includes a gripper body 330, a finger fixing block 340, an up-and-down operation unit 350, and a finger 360.

The base plate 254 is coupled to the gripper transfer unit. That is, the base plate 254 is a member, connected to the linear driver, the output ends of an articulated robot without multi-joints, etc., for supporting the gripper body 330 according to the present invention. The base plate 254 may be implemented in various forms or include separated brackets formed in various structures in order to be coupled to various types of transfer units.

The base plate 310 is configured in such a way that the lower end coupled to the gripper body 330 is formed to be a plate structure and the one end (front) forms a shaft hole 311 that a tilt rotation shaft 320 passes through.

The gripper body 330 is a housing structure for supporting or housing the components of the gripper 300. The gripper body 330 is coupled to the lower side of the base plate 254 configuring the rotation transfer unit 250 and is shaped as a block-form extending to the vertical lower side.

The gripper body 330 is coupled to the base plate 254 with the tilt rotation shaft 320. The gripper body 330 forms, in the one upper end (front), a shaft hole 3310 corresponding to the shaft hole 3547 of the base plate 254.

The tilt rotation shaft 320 coupling the base plate 254 and the gripper body 330 is axially installed in the left-right direction (X′) crossing the front-back direction (Y′), to move close to or apart from the test tube 2 by the gripper transfer unit 200. Therefore, the gripper body 330 can be rotated in the front and back directions about the tilt rotation shaft 320.

The structure of the tilt rotation shaft 320 allows the gripper body 330 to be usually perpendicular to the base plate 254 (in vertical direction) by the weight. When the gripper body 330 experiences the change of the center of gravity due to the structure of the finger 360 protruded in the front direction or a condition as to whether to hold a test tube 2, the rotated position may vary. In order to precisely release the gripped test tube, the gripper body 330 needs to always keep the perpendicular position to the base plate 254 (vertical direction) regardless of a condition as to whether to hold a test tube 2.

In the embodiment, the tilt rotation shaft 320 coupling the base plate 254 and the gripper body 330 is configured to be leaned forward from the vertical line passing through the center of gravity of the gripper body 330 (when gripping a test tube). The base plate 254 includes, in the one side, a first position-limiting stopper 313 contacting one end of the gripper body 330. The gripper body 330 is rotated by the weight about the tilt rotation shaft 320, so that the one end contacts the first position limiting stopper 313, and thus this prevents the gripper body 330 from being rotated forward over the vertical line passing the tilt rotation shaft 320. The base plate 254 may further include, in the other side, a second position-limiting stopper 315 contacting the other end of the gripper body 330. When the base plate 254 includes, in the other side, a second position-limiting stopper 315, the maximum rotation angle of the gripper body in the back direction is limited by the repulsive force transmitted from the test tube 2 while gripping the test tube 2. The forward-backward angle D1 assigned to the gripper body 330 is set as an angle corresponding to the forward-backward slopes of the test tube 2 fitted into the hole 11 of the pallet 10. Therefore, the tilt rotation angle of the gripper body 330 may be adjusted by properly altering the interval between the first position limiting stopper 313 and the second position limiting stopper 315.

In addition, a first return spring 325 for separating the gripper body 330 from the base plate 254 and restoring the gripper body 330 to the vertical position may be installed between the gripper body 330 and the base plate 254 provided to the rotation transfer unit 250. The first return spring 325 may rapidly restore the gripper body 330 to the vertical position and allow the gripper body 330 to keep the position, compared with the operations where the gripper body 330 is rotated backward about the tilt rotation shaft 320 and then returned to the vertical position by the weight. The first return spring 325 needs to be designed to have an elastic coefficient so that the gripper body 330 can be easily rotated backward by the repulsive force transmitted from the test tube 2.

In the embodiment, the gripper body 330 includes: an upper fixing part 331 that is coupled to the tilt rotation shaft 320 and the base plate 254 of the rotation transfer unit 250 and has an up-and-down operation unit 350 therein; a lower fixing part 333 that is arranged downward apart from the upper fixing part 331 to secure a space where the finger fixing block 340 moves up and down; and a connection housing 332 connecting the upper fixing part 331 and the lower fixing part 333.

The upper fixing part 331 is shaped as the Korean character ‘, read as di-geut,’ in cross-section seen from the side. The upper front end of the upper fixing part 331 is coupled to the base plate 254 with the tilt rotation shaft 320. The upper fixing part 331 includes, in the center inside, an up-down driving motor 351 configuring the up-and-down operation unit 350.

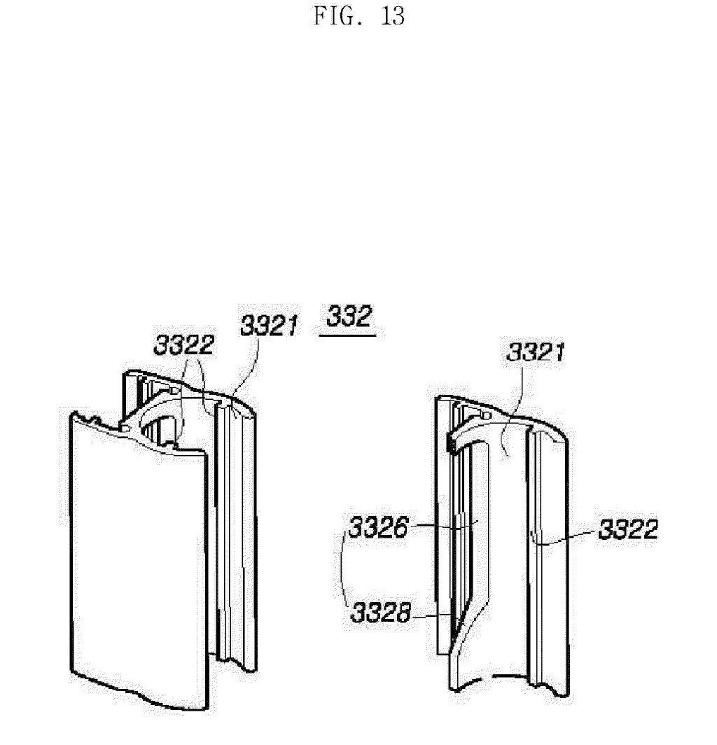

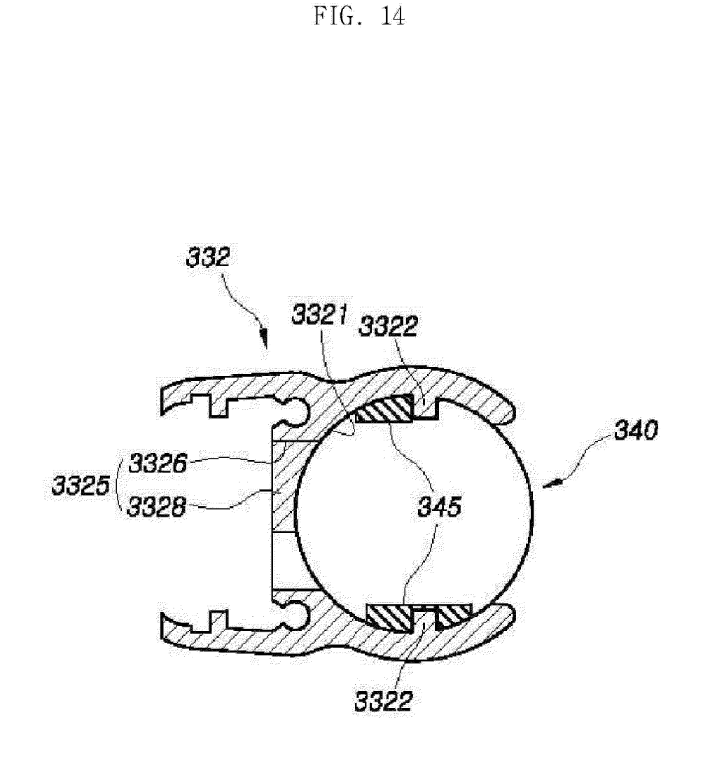

Referring to FIGS. 13 and 14, the connection housing 332 is configured in such a way as to cover the finger fixing block 340 moving up and down and to be open forward allowing the gripping end of the finger 360 to be protruded. The connection housing 332 installs a board panel 3320 shown in FIG. 11 to the back side. The board panel 3320 provides a space in which various sensors, a control panel and cables are arranged.

The connection housing 332 includes a sliding surface 3321 for guiding the finger fixing block 340 to move up and down, in the front inside. The sliding surface 3321 forms a plurality of guide rails 3322 perpendicular thereto.

The rear end of the sliding surface 3321 is integrally formed with a gripping cooperation guide 3325 connected to the finger 360. The gripping cooperation guide 3325 includes a vertical guide unit 3326 vertically extended from to the top to the bottom; and a slant guide unit 3328 slantingly extended from the bottom of the vertical guide unit 3326 to the side.

The finger fixing block 340 is a member for fixing and supporting the finger 360, and vertically moves up and down with respect to the gripper body 330.

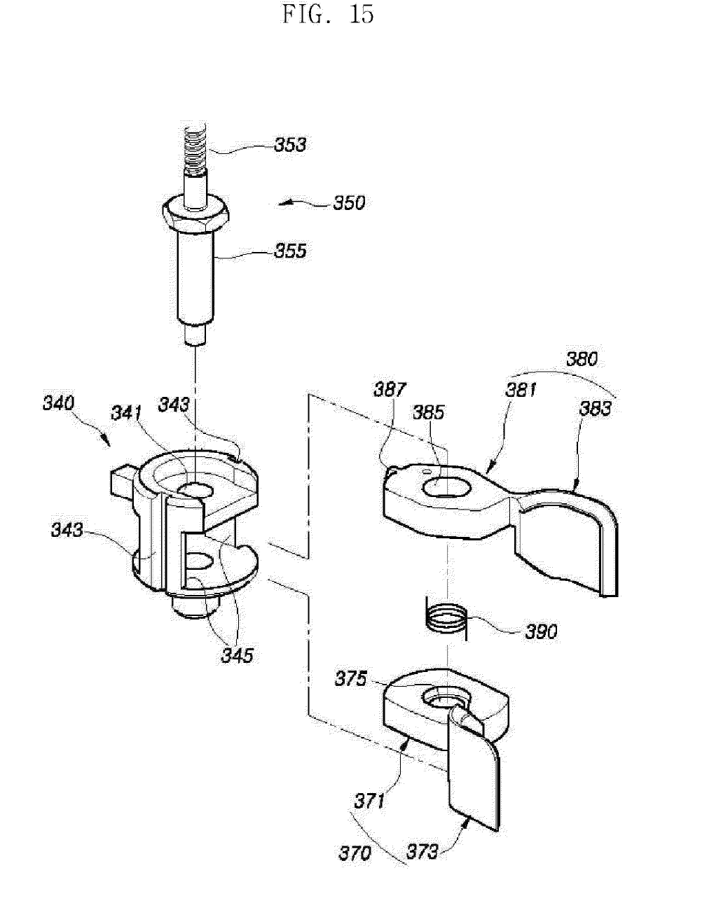

Referring to FIG. 15, in the embodiment, the finger fixing block 340 is fitted to the sliding surface 3321 of the connection housing 332 and guided in the up-and down movement. The finger fixing block 340 forms, on the outer surface, a guide groove 343 that the guide rail 3322 formed on the sliding surface 3321 is fitted into to guide the up-and-down movement.

The finger fixing block 340 forms a shaft hole 341 that a hinge shaft 355 of the up-and-down driving shaft 353 configuring the up-and-down operation unit 350 extends through and couples to. The finger fixing block 340 includes, at both opposite sides, finger supports 345 contacting a first fixing piece 371 and a second fixing piece 381 which configures the finger 360.

The finger fixing block 340 linearly reciprocates between the upper end and the lower end of the connection housing 332 according to the operation of the up-and-down operation unit 350.

The up-and-down operation unit 350 is coupled to the finger fixing block 340 to provide an up-and-down driving force to the finger fixing block 340. The up-and-down operation unit 350 provides an up-and-down driving force to the finger fixing block 340 and a gripping force to the finger 360, simultaneously.

Referring back to FIG. 11, in the embodiment, the up-and-down operation unit 350 includes: an up-and-down driving motor 351 installed to the upper fixing part 331; and an up-and-down driving shaft 353, connected to the up-and-down driving motor 351, for moving up and down. More specifically, the up-and-down driving shaft 353 forms screws and is coupled in screw form to the up-and-down driving motor 351. The hinge shaft 355 formed at the bottom end of the up-and-down driving shaft 353 is rotatably coupled to the finger fixing block 340.

The screw-type up-and-down driving shaft 353 is linearly moved up and down, according to the forward or reverse rotation of the up-and-down driving motor 351. The finger fixing block 340 is also linearly moved up and down, in the connection housing 332, cooperating with the up-and-down driving shaft 353.

The finger 360 includes a first gripping part 373 and a second gripping part 383 that are place opposite positions to hold a test tube 2 by pressing both the opposite sides on the outer surface of the test tube 2.

As described above, the finger 360 grips and releases a test tube 2, cooperating with the up-and-down movement of the finger fixing block 340 by the up-and-down operation unit 350, without using a separate driving unit for gripping or releasing the test tube 2.

More specifically, as the up-and-down operation unit 350 operates, the first and second gripping parts 373 and 383, facing to each other when the finger fixing block 340 is moved down, are spaced apart from each other to receive a test tube 2 in the space therebetween. In addition, as the up-and-down operation unit 350 operates, the first and second gripping parts 373 and 383, facing to each other when the finger fixing block 340 is moved up, move close to each other to grip a test tube 2 therebetween.

Referring back to FIG. 15, in the embodiment, the finger 360 includes a first finger 370 and a second finger 380.

The first finger 370 include: a first fixing piece 371 coupled to the finger fixing block 340; and a first gripping part 373 extended from one end of the first fixing piece 371. The first fixing piece 371 includes, at the middle, a first shaft hole 375 that the hinge shaft 355 of the up-and-down driving shaft 353 passes through. The first fixing piece 371 is configured so that the outer surface contacts the finger supports of the finger fixing block 340.

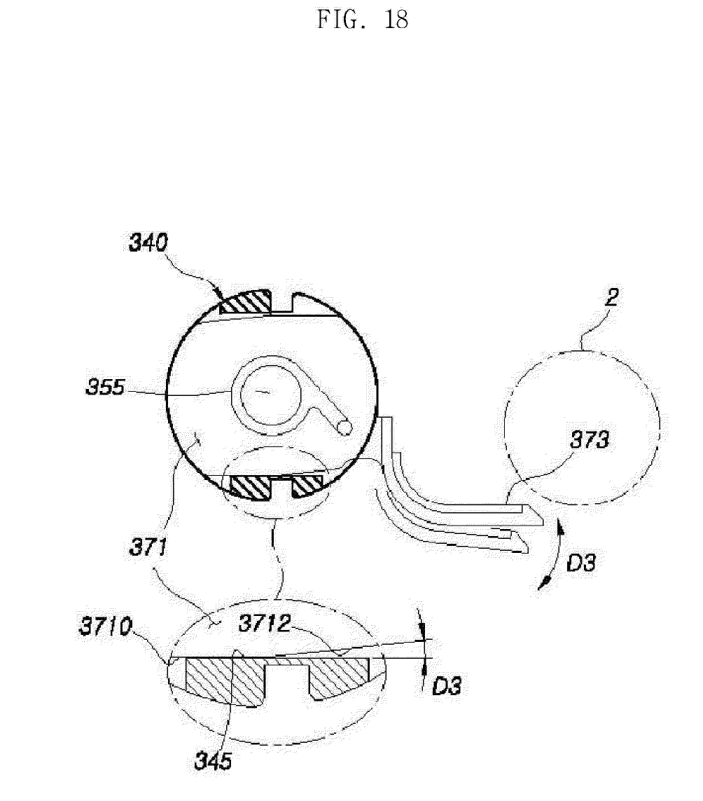

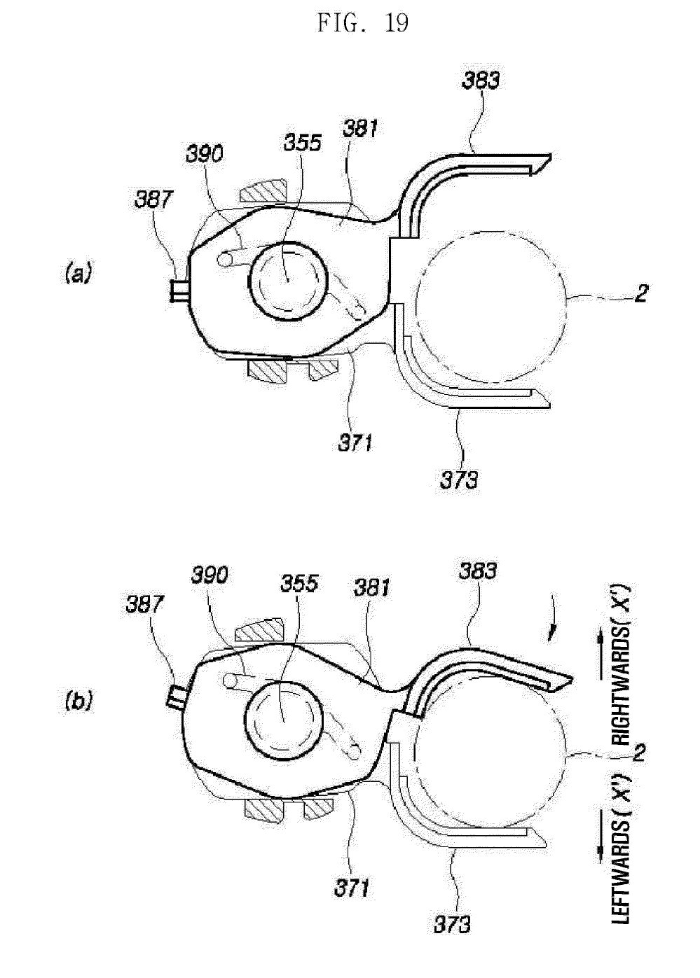

Referring to FIGS. 18 and 19, the first fixing piece 371 forms the outer surfaces so that it can move and rotate in both the left and right directions about the hinge shaft 355, maintaining a gap between the outer surfaces and the finger supports 345. More specifically, the finger supports 345 provided to both the sides of the finger fixing block 340 are formed in flat; the outer surfaces of the first fixing piece 371 contacting the finger supports 345 form first and second support surfaces 3710 and 3712 with a certain degree of slope D3.

The first finger 370 meets a structure that can move and rotate, about the hinge shaft 355, in both the left and right directions corresponding to the slope D3 of the first and second support surfaces 3710 and 3712. The left-right direction angle D3 assigned to the first finger 370 is set as an angle corresponding to the left-right direction slopes of the test tube 2 the lower part of which is fitted into the hole 11 of the pallet 10. Therefore, the left-right direction rotation angle D3 of the first finger 370 may be set by properly altering the slope D3 of the first and second support surfaces 3710 and 3712.

The second finger 380 includes: a second fixing piece 381 coupled to the finger fixing block 340; and a second gripping part 383 that is extended from one end of the second fixing piece 381 and faces the first gripping part 373. The second fixing piece 381 is coupled in layer to the first fixing piece 371, and the second gripping part 383 is configured to keep the position facing the first gripping part 373. The second fixing piece 381 includes, at the middle, a second shaft hole 385 that the hinge shaft 355 of the up-and-down driving shaft 353 passes through. The second fixing piece 381 includes a protrusion support 387 contacting a gripping cooperation guide 3325 of the connection housing 332, at one end of the outer surface opposite to the second gripping part 383. It is preferable that the protrusion support 387 is equipped with a roller or a bearing to reduce noise and frictional resistance when contacting the gripping cooperation guide 3325, thereby performing stable operation.

The first and second fingers 370 and 380 are elastically installed so that the first gripping part 373 and the second gripping part facing to each other are close to each other and maintain a pressed state. Referring to FIGS. 15 and 19, the embodiment is implemented in such a way that: a second return spring 390 is placed between the first and second fixing pieces 371 and 381 that are stacked in layer; and the first and second gripping parts 373 and 383 move close to each other with respect to the hinge shaft 355, and are pressing each other. Therefore, the second return spring 390 applies the gripping force to the sides of a test tube 2, and the gripping force can be controlled by properly altering the elastic coefficient.

Referring to FIG. 19A, in a state where the first and second fingers 370 and 380 are maximally moved down, the protrusion support 387 of the second fixing piece 381 is guided to the slant guide unit 3328 of the connection housing 332 and the second gripping part 383 is separated from the first gripping part 373. When the first and second fingers 370 and 380 starts to moved up from the maximally lowered position according to the operation of the up-and-down operation unit 350, the second gripping part 383 is guided toward the first gripping part 373 by the slant guide unit 3328, thereby gradually moving to the first gripping part 373.

As described above, in a state where the first and second fingers 370 and 380 are maximally lowered and the first and second gripping parts 373 and 383 are spaced apart from each other, since the first finger 370 maintains the slope D3 of the first and second support surfaces 3710 and 3712 contacting the finger supports 345 of the finger fixing block 340. Therefore, the first finger 370 meets a structure that can overcome the restoration force of the second return spring 390 when a repulsive force is applied to the first gripping part 373 and can rotate in the outer side (left direction) by the slope D3 of the first and second support surfaces 3710 and 3712.

In addition, since the second finger 380 is installed to be rotated about the hinge shaft 355 and the other end of the protrusion support 387, not contacting the slant guide unit 3328, is formed to be open, the second finger 380 meets a structure that can overcome the restoration force of the second return spring 390 to move and rotate outward (in the right direction) when a repulsive force is applied to the second gripping part 383.

Referring to FIG. 9B, when the finger fixing block 340 is moved up as the up-and-down operation unit 350 operates, the protrusion support 387 of the second fixing piece 381 escapes from the slant guide unit 3328 of the connection housing 332 and is supported by the vertical guide unit 3326. Therefore, the second gripping part 383 is rotated about the hinge shaft 355 by the restoration force of the second return spring 390 and moves close toward the first gripping part 373, thereby gripping the test tube 2.

As described above, although the first and second gripping parts 373 and 383 hold test tubes, the first finger 370 meets a structure that can overcome the restoration force of the second return spring 390 and can move and rotate outward (in the left direction) by the slope D3 of the first and second support surfaces 3710 and 3712; and the second finger 380 meets a structure that can overcome the restoration force of the second return spring 390 and can be rotated outward (in the right direction).

The following description is provided regarding a sensor that can be applied to the gripper 300 configured as described above.

The embodiment may include sensors for sensing the upper and lower limits for the maximum raised position and maximum lowered position of the finger 360. It is preferable that the upper and lower limit sensing sensors are installed to a connection board 3320 included in the connection housing 332 that provides an up-and-down movement interval of the finger fixing block 340 coupled with the finger 360. The up-and-down movement interval of the gripper 300 may be set be greater than a height that allows a test tube 2 to be separated from the hole 11 of the pallet 10, or a depth of the hole 11. Although the operations of the up-and-down operation unit 350 may be implemented by presetting the up-and-down movement interval, when the embodiment receives the precise upper and lower limit positions from the upper and lower limit sensing sensors each time and controls the operations of the up-and-down operation unit 350 based on the received positions, it can increase the speed and precision of control of the gripper 300.

In addition, in order to detect whether a test tube 2 precisely enters between the first and second fingers 370 and 380 (a position to be gripped) while the gripper 300 is advancing toward the test tube 2 by the gripper transfer unit 200, a sensor may be employed to sense a test tube insertion position. The test tube insertion position sensing sensor may be installed to one of the following: the finger 360, finger fixing block 340, connection housing 332 and lower fixing part 333.

In addition, since the gripper 300 is implemented to cooperate with the raising and gripping operations the finger 360 to separate the test tube from the hole 11 of the pallet 10, it is preferable to employ a sensor for sensing the height of a test tube 2 to determine whether the test tube 2 is completely separated from the hole 11 of the pallet 10 after completing the raising and gripping operations of the finger 360. The test tube height sensing sensor may be installed to the front side of the connection housing 332 or the upper fixing part 331 of the gripper body 330 that can face the upper end of the test tube 2 gripped by the finger 360.

In a state where the test tube height sensing sensor is employed, when the lower part of the test tube 2 is fitted into the hole 11 of the pallet 10 as the finger 360 performs raising and gripping operations, a strong frictional force between the hole 11 and the test tube 2 may cause a repulsive force. In this case, when the finger 360 pressing the sides of the test tube 2 is raised, it may be slipped from the test tube 2. At this moment, although the finger 360 remains the maximum raising position, the test tube 2 may not be completely separated from the hole 11 of the pallet 10. In this case, the test tube height sensing sensor senses the malfunction that occurred while the test tube 2 is being raided (separated), thereby allowing the gripper 300 to stop the operation or operating notifying units, such as, a buzzer, a lamp, a display, etc., so that the malfunction can be rapidly removed.

Referring to FIG. 9, reference number S1 refers to a ‘test tube presence checking sensor.’ The test tube presence checking sensor S1 is installed to one side of the rear of the gripper 300 to sense the rear area of the gripper 300. For example, before the left-right transfer unit 210 of the gripper transfer unit 200 operates and the gripper 300 is transferred to the left and right reception units 110A and 110B in order to hold test tubes 2 received in the left and right reception units 110A and 110B, the test tube presence checking sensor S1 checks a condition as to whether the test tube 2 is received in the left reception unit 110A or right reception unit 1108, thereby preventing the gripper transfer unit 200 from performing unnecessary transfer operations. In addition, since the finger 360 is installed to the front area of the gripper 300 and various types of sensors for sensing whether test tubes 2 are gripped or the gripping states of test tubes 2 are also provided to the front area of the gripper 300, the test tube presence checking sensor S1 is not affected from the finger 360 and the various types of sensors.

Therefore, the front-back transfer unit 230 of the gripper transfer unit 200 operates between the left and right reception units 110A and 110B; the presence of a test tube 2 is previously checked while the gripper 300 is transferred in the front-back direction Y; the rotation transfer unit 250 of the gripper transfer unit 200 operates to rotate the gripper by 180°; and the left-right transfer unit 210 of the gripper transfer unit 200 operates to transfer the gripper 300 to the corresponding test tube 2.

The following description is provided regarding a method for the gripper 300, including the components described above, to separate and transfer test tubes 2 from holes 11 of the pallet 10.

The left-right transfer unit 210 of the gripper transfer unit 200 operates to move the gripper 300 in the front direction toward the left reception unit 110A or right reception unit 1108 in which the pallets 10 are placed.

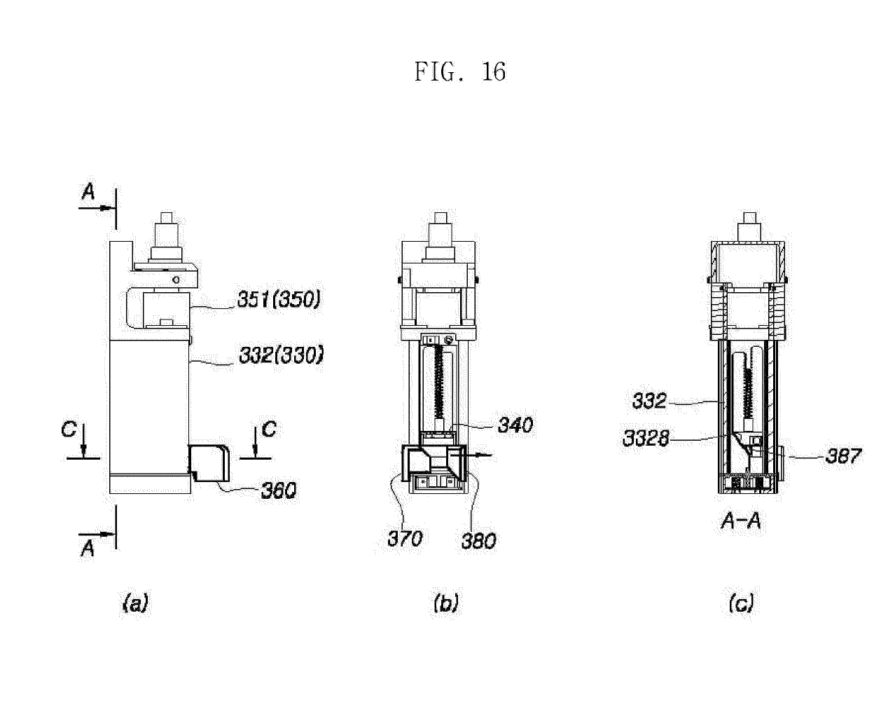

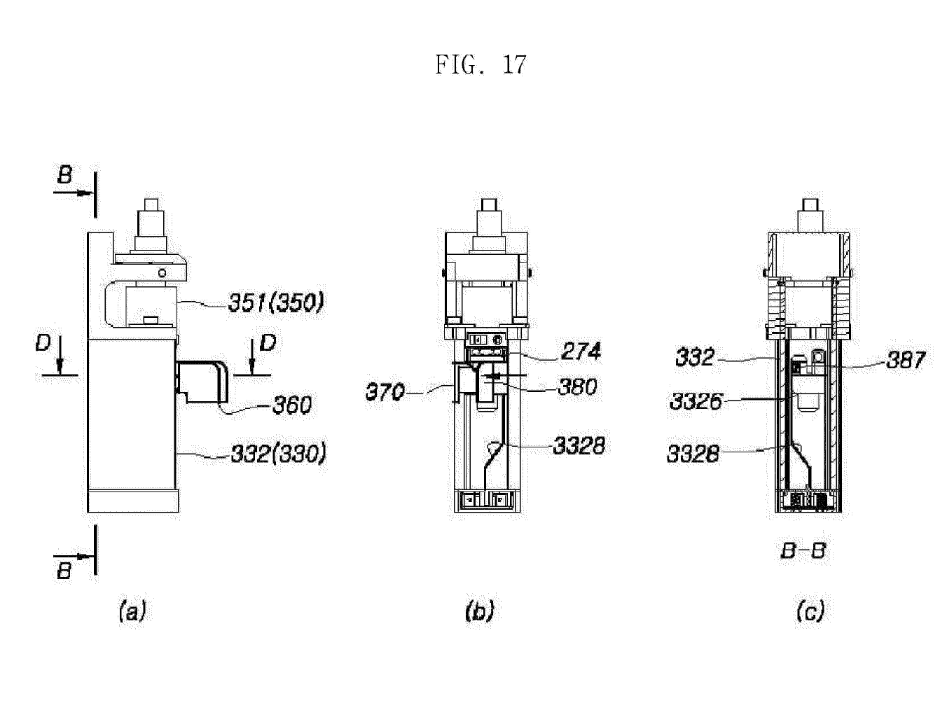

As shown in FIGS. 16A to 16C and 19A, the gripper 300 keeps the vertical position with respect to the tilt rotation shaft 320 by the first return spring 325 and the weight of the gripper body 330 from the base plate 254. In addition, the first and second fingers 370 and 380 keep the maximum lowed state to the bottom of the connection housing 332; and the protrusion support 387 of the second finger 380 is supported by the slant guide unit 3328 of the connection housing 332 to overcome the restoration force of the second return spring 390, and is spaced apart from the first finger 370 with respect to the hinge shaft 335.

While a test tube is inserted between the first and second fingers 370 and 380 as the gripper transfer unit 200 continues to operating, the test tube insertion position sensing sensor senses whether the test tube is precisely inserted between the first and second fingers 370 and 380. The gripper transfer unit 200 stops the forward movement based on the signal received from the test tube insertion position sensing sensor, and then the processes of gripping and separating the test tube are performed.

While a test tube 2 is inserted between the first and second fingers 370 and 380, when the side of the test tube slightly contacts the first or second finger 370 or 380, the first and second fingers 370 and 380 each receive the repulsive force of the test tube 2, in the left-right direction X′, with respect to the hinge shaft 355. The test tube 2 that contacted a corresponding finger 360 is moved the opposite direction by the restoration force of the second return spring, so that the test tube can be located at the more precise position between the first and second fingers 370 and 380.

Although the test tube is inserted in a hole 11 of the pallet 10 in an incorrect position state, such as being inclined in the left-right direction X′, the present invention can smoothly insert the test tube 2 between the first and second fingers 370 and 380. Since the test tube elastically collides with the fingers by the second return spring 390, the present invention can prevent the test tube from being damaged.

In addition, since the first and second fingers 370 and 380 secure gaps extended to the left and right respectively, although the present invention employs a low-priced sensor of a relatively low level of accuracy instead of an expensive, test tube insertion position sensing sensor of a relatively high level of accuracy, it can achieve the same operation control effect.

When a test tube has been inserted between the first and second fingers 370 and 380, the up-and-down operation unit 350 is raised to lift up the first and second fingers 370 and 380 along with the finger fixing block 340 and simultaneously grips and separates the test tube 2.

That is, the up-and-down driving motor 351 operates to lift up the first and second fingers 370 and 380 along with the finger fixing block 340. In the beginning stage of the lifting operation, the protrusion support 387 of the second finger 380 is guided along the slant guide unit 3328 of the connection housing 332, and simultaneously the second fixing piece 381 is rotated about the hinge shaft 355 to move close toward the first fixing piece 371.

When the protrusion support 387 of the second finger 380 escapes from the slant guide unit 3328 while moving up, the first and second fingers 370 and 380 simultaneously contact and hold both sides of the test tube 2.

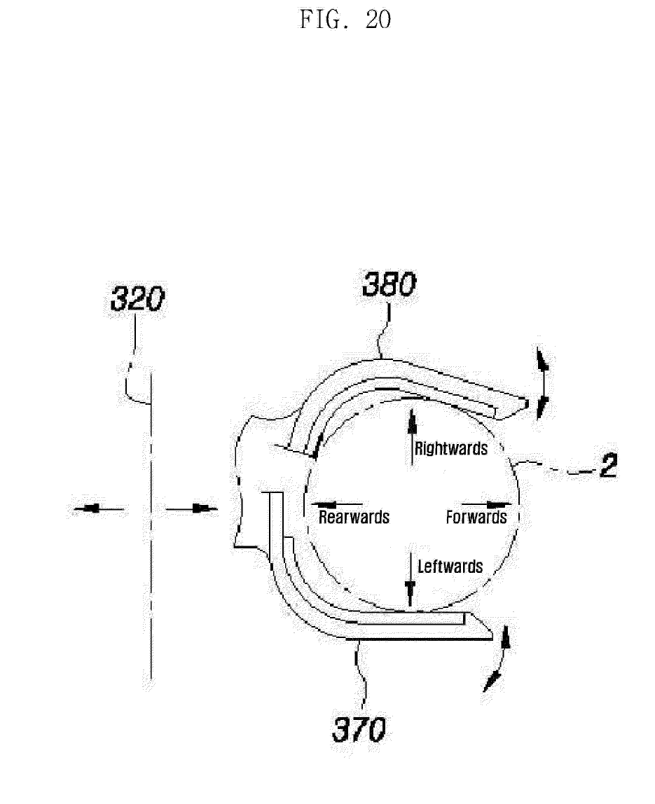

Referring to FIG. 20, when the first and second fingers 370 and 380 grip a test tube 2 while moving up, the test tube 2 may be inclined in the front-back direction Y′. In this case, the gripper body 330 is rotated backward about the tilt rotation shaft 320 by the repulsive force of the front-back direction Y′ transmitted from the test tube 2, and is then returned to rotate in the reverse direction by the weight of the gripper body 330 and the restoration force of the first return spring 325.

Therefore, the test tube 2 gripped by the first and second fingers 370 and 380 experiences the posture correction and is then returned to the vertical position by the tilting operation in the front-back direction Y′. After that, as the up-and-down operation unit 350 continues to move up, the test tube 2 gripped by the first and second fingers 370 and 380 can be easily separated from the hole 11 of the pallet 10.

In addition, the rotation operation that the first and second fingers 370 and 380 performs about the tilt rotation shaft 320 in the front-back direction Y′ is similar to the operation as if the user's hand twists and raises (separates) the test tube. Therefore, although the test tube 2 is tightly fitted into the hole 11 of the pallet 10, the present invention can easily separate the test tube 2 from the hole 11 of the pallet 10.

Meanwhile, when the first and second fingers 370 and 380 grip a test tube 2 while moving up, the test tube 2 may be inclined in the left-right direction X′. In this case, the first and second fingers 370 and 380 are independently rotated in the left-right direction X′ by the repulsive force of the left-right direction X′ transmitted from the test tube 2, and are then returned to rotate in the reverse direction by the restoration force of the second return spring 390.

As the rotation in the front-back diction Y′, the test tube 2 gripped by the first and second fingers 370 and 380 experiences the posture correction and is then returned to the vertical position by the rotation operation in the left-right direction X′. Therefore, the test tube 2 can be easily separated from the hole 11 of the pallet 10. The rotation and movement operations that the first and second fingers 370 and 380 perform in the left-right direction X′ is similar to the operation as if the user's hand twists and raises (separates) the test tube. Therefore, although the test tube 2 is tightly fitted into the hole 11 of the pallet 10, the present invention can easily separate the test tube 2 from the hole 11 of the pallet 10.

The gripper 300 can rapidly and accurately the processes of gripping and separating a test tube without malfunction, considering an incorrect posture with which the test tube is inserted into the hole 11 of the pallet 10 in the front-back direction Y′ or left-right direction X′ or an extent of tightness that the test tube is inserted to the hole 11 of the pallet 10.

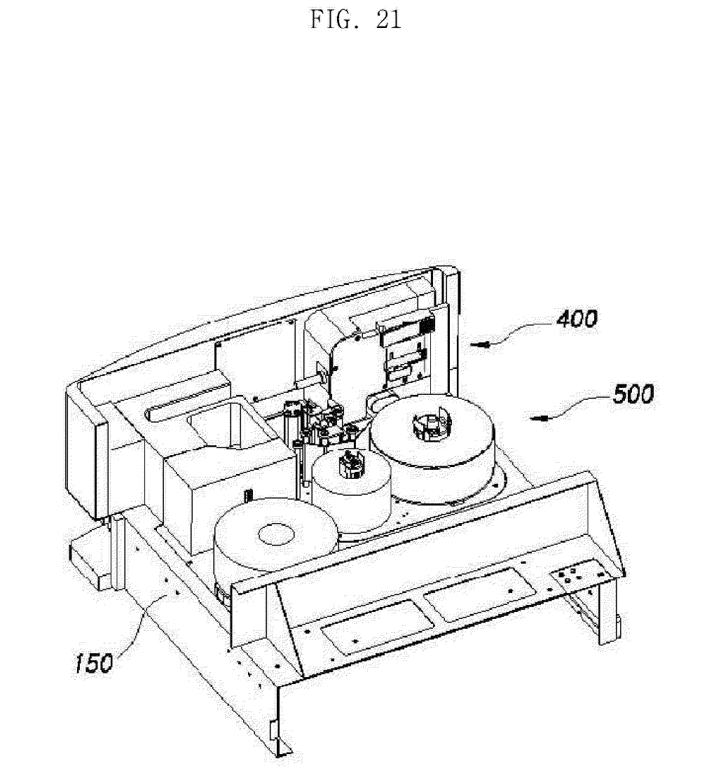

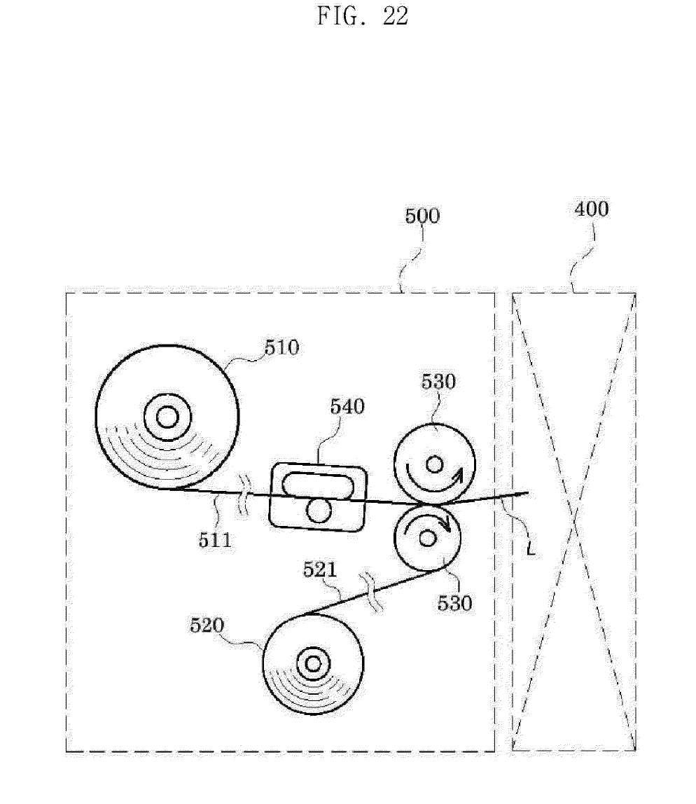

Referring to FIGS. 21 and 22, a labeling unit 400 is installed onto the lower frame 150, one side of which a label supplying device 500 is installed onto to supply label papers to the labeling unit 400. The label supplying device 500 includes: a layout sheet roll 510 on which a label layout sheet 511 is wound in roll form; and a release sheet roll 520 for collecting a release paper 521 released from the layout sheet roll 510. When the label layout sheet 511 is unwound from the layout sheet roll 510, the release paper 521 is wound on the release sheet roll 520 and the label paper L is supplied to the labeling unit 400 by the driving force of a supply roller 530. The label supplying device 500 may further include a printer unit 540 between the layout sheet roll 510 and the release sheet roll 520. The printer unit 540 previously prints particular label information on the label layout sheet 511 unwound from the layout sheet roll 510. The technology related to the label supplying device 500 may be variously modified from well-known technologies. The detailed description is omitted in the following description not to obscure the subject matter of the present invention.

The labeling unit 400: receives a test tube 2 that the gripper 300 and the gripper transfer unit 200 pass through the guide hole 115 and transfer down to the inside, and places and fixes the received test tube 2 therein; rotates the test tube 2 along with a label, supplied from the label supplying device 500, which is pressed around the test tube 2, thereby attaching the label to the test tube 2; and discharges the labeled test tube 2 to the outside. The labeling unit 400 is installed on the lower frame 150 so that the labeling unit 400 is arranged below the guide hole 115.

The label supplying device is installed to one side of the labeling device and supplies label papers cooperating with the labeling device. The label supplying device, arranged in one side of the labeling device, supplies labels on which particular label information has been printed, to the labeling device according to the present invention. The label supplying device includes: a layout sheet roll on which a label layout sheet is wound in roll form; and a release sheet roll for collecting a release paper released from the layout sheet roll. When the label layout sheet is unwound from the layout sheet roll, the release paper is wound on the release sheet roll and the label paper is supplied to the labeling device. The label supplying device may further include a printer unit between the layout sheet roll and the release sheet roll. The printer unit previously prints particular label information on the label layout sheet unwound from the layout sheet roll. The technology related to the label supplying device and the printer unit may be variously modified from the well-known technologies.

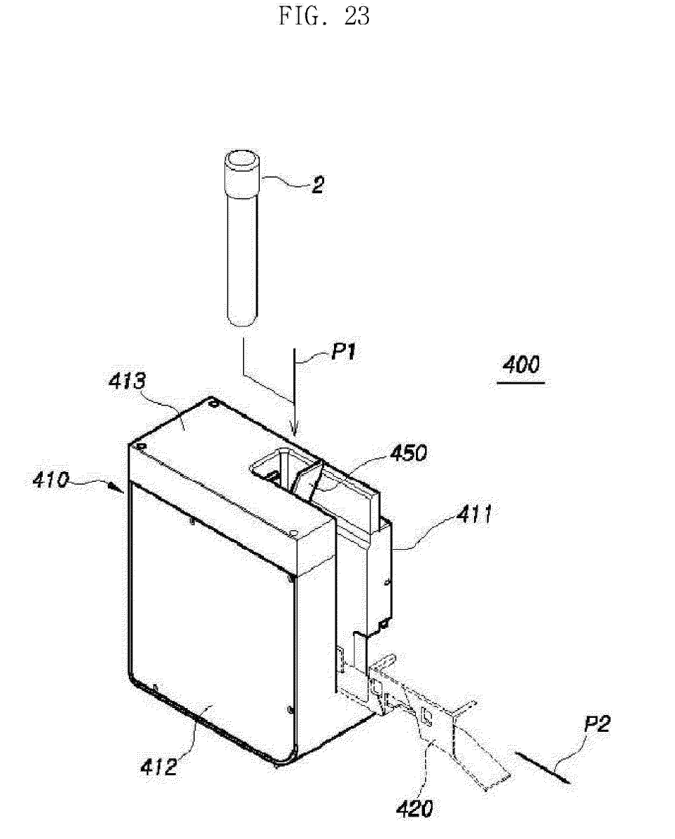

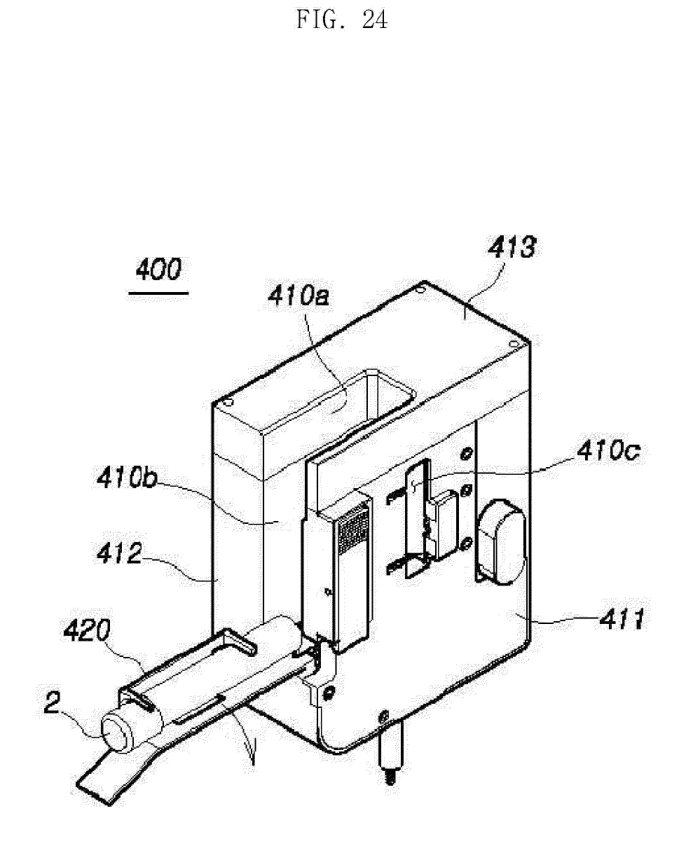

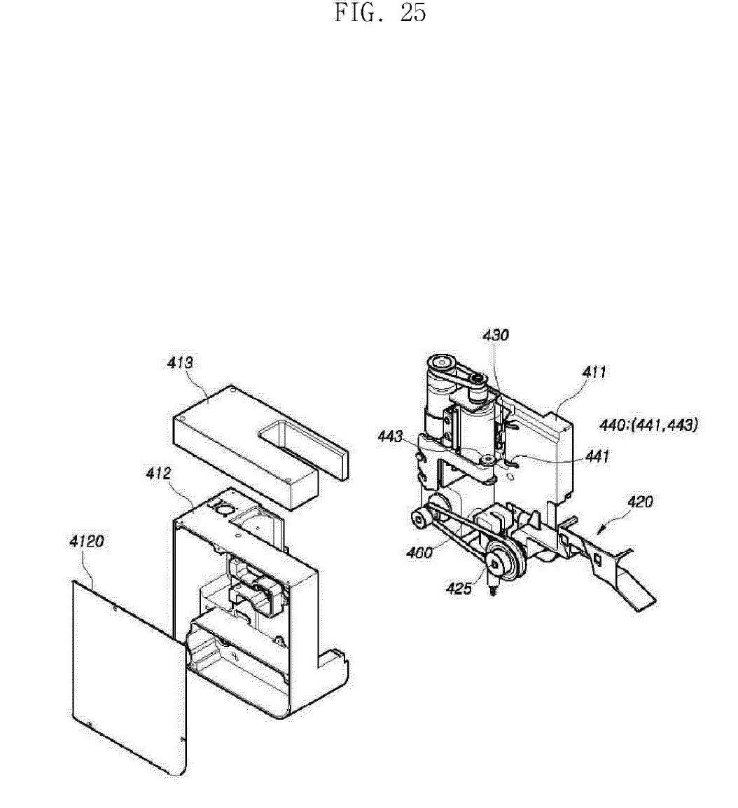

Referring to FIGS. 23, 24, and 25, the labeling unit 400 is configured to include a labeling frame 410, a holding member 420, a drive roller 430, and a pressure roller 440.

The labeling frame 410 allows for the installation of the respective components of the labeling unit 400 and supports the components. The labeling frame 410 is configured in such a way as to form: on the upper side, a test tube inflow hole 410a for receiving a test tube 2 passing through the guide hole 115 of the upper frame 110; on the back side, a label supplying slot 410c for receiving label papers supplied from the label supplying device 500; and on one side, a test tube discharging hole 410b for discharging the test tube affixed with a label. The label supplying slot 410c includes a label paper sensing sensor for detecting the presence of a label paper. In the embodiment, the labeling frame 410 is coupled with a rear frame 411, a front frame 412, and an upper frame 413, and thus is shaped as a tetrahedron in overall form. As the rear frame 411, front frame 412, and upper frame 413 are assembled to each other, the inflow hole 410a on the upper side and the discharging hole 410b on the side form a structure shaped as the Korean character ‘, read as gi-yeok.’

The holding member 420 fixedly supports the received test tube 2 to be located at a proper height, so that the test tube 2 can be affixed with a label on the outer surface at the height. The holding member 420 may also rotate the labeled test tube 2 to discharge it to the side direction. That is, the holding member 420 is coupled to the labeling frame 410 so that it can rotate between a first position P1 from which the test tube 2 passing through the guide hole 5 of the upper frame 110 flows into the inside and a second position P2 from which the test tube 2 is discharged. As shown in FIGS. 23 to 25, the test tube 2 is completed inserted into the inside of the labeling frame 410 at the first position P1 and is protruded out of the labeling frame 410 at the second position P2.

Although the embodiment shown in FIGS. 23 to 25 is implemented in such a way that the test tube 2 is in a vertical state at the first position P1 and in a horizontal state at the second position P2, it should be understood that the embodiment may be modified in such a way as to receive the test tube 2 in a horizontal state and to discharge it in a vertical state.

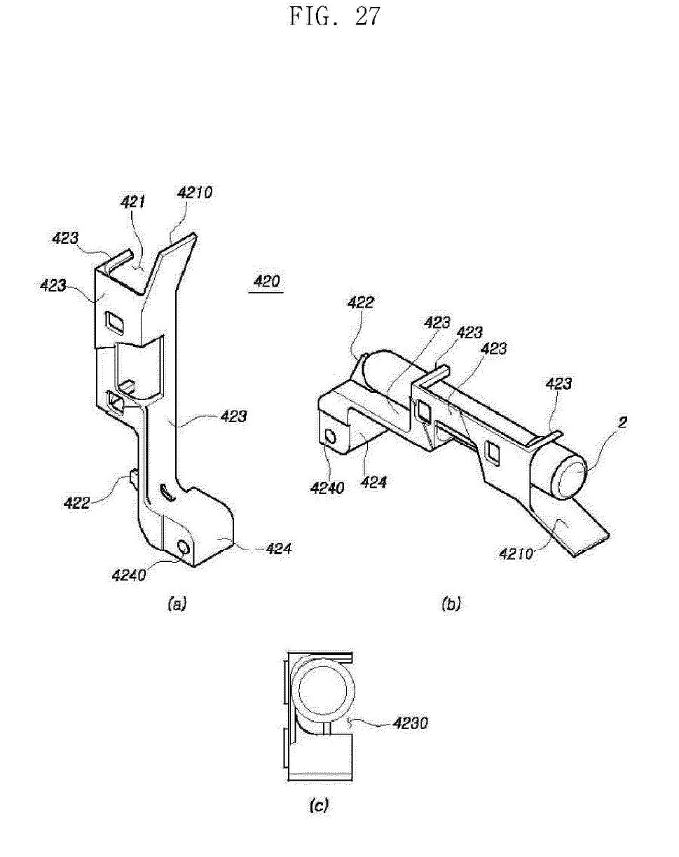

Referring to FIG. 27, the holding member 420 according to the embodiment forms a single body including: an upper inflow opening 421 for introducing a test tube 2 passing through the inflow hole 410a of the labeling frame 410 into the inside; a lower stopper 422 for supporting the lower end of the introduced test tube 2; and a side stopper 423 for blocking the separation of the introduced test tube 2 by connecting the upper inflow opening 421 and the lower stopper 422.

The upper inflow opening 421 may include a slant guide unit 4210 for guiding the introducing process of the test tube 2 moving close from the outside.

The side stopper 423 is configured in such a way that: while the side stopper 423 rotates to the second position P2 to discharge a test tube 2 later, it can also rotate the test tube 2 located in the inside. The inside space formed by the side stopper 423 is larger than a space by the diameter of the test tube 2. The side stopper 423 is configured not to completely surrounding the test tube 2, but to allow the label paper, the driver roller 430 and the pressure roller 440, placed beside the holding member 420, to contact the circumference of the test tube introduced into the holding member 420. The side stopper 423 is configured in such a way that the area where the label paper, the driver roller 430 and the pressure roller 440 are arranged is partially opened, so that the holding member 420 cannot be affected by the components while the holding member 420 is rotated. Therefore, the side stopper 423 according to the present invention may be implemented in any type of structure if the structure is formed to prevent the test tube 2 from being separated from the holding member 420 while the side stopper 423 rotates the test tube 2 from the first position P1 to the second position P2 along with the lower stopper 422.

The side stopper 423 forms, on one side, a side opening 4230 for allowing the separation of a test tube 2. The side opening 4230 is formed at the side orthogonal to the rotation direction, so that the test tube 2 cannot be separated to the side opening 4230 while the holding member 420 rotates from the first position P1 to the second position P2. That is, as shown in FIGS. 27A to 27C, the side stopper 423 including the side opening 4230 is shaped as the Korean character ‘, read as di-geut,’ in cross-section seen from the side. It should be understood that the side stopper 423 including the side opening 4230 may also be shaped as an arc form, or the alphabet ‘C’ in cross-section.

The lower stopper 422 of the holding member 420 includes an extension bracket 424 forming a shaft hole 4240. The lower stopper 422 passes through the shaft hole 4240 and is coupled to a rotation shaft 425 of the frame 410.

The holding member 420 may include a test tube sensing sensor (not shown) for sensing a type of test tube (or the height) and the presence of a test tube inserted from the first position P1. The test tube sensing sensor may precisely check the discharge of a test tube during the discharging process.

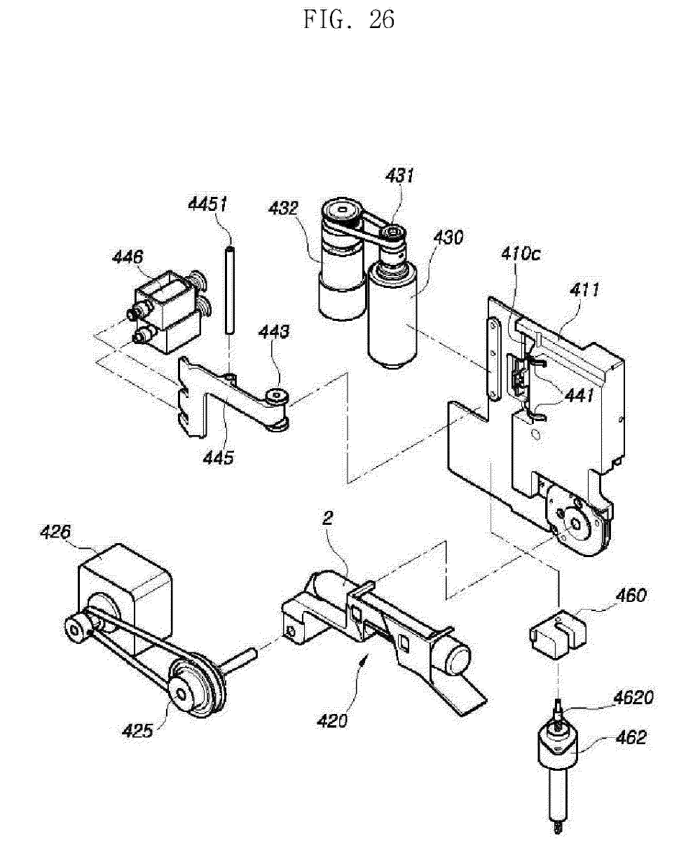

The rotation shaft 425 of the holding member 420 may be directly coupled to the output shaft of a swing motor 426. As shown in FIG. 26, the swing motor 426 is arranged to the side of the rotation shaft 425, and the output shaft of the swing motor 426 and the rotational shaft 425 are coupled to each other by a motive power transmission member of a belt and pulley mode, so that the frame 410 can be compact in volume with respect to the front-back direction.

When the test tube 2 is introduced to the inside from the first position P1, the holding member 420 is operated in such a way that the lower stopper 422 supports the lower end of the test tube 2. Since the left and right reception units 110A and 110B may receive various types of test tubes 2 in size (length) according to types of tests or contents, when the received test tubes 2 are long and different in length from each other and affixed with labels, the levels of the test tubes to which the labels are attached are relatively low compared to the length. Therefore, for various types of test tubes, the holding member 420 cannot secure the uniformity of location of the test tubes to which labels are attached.

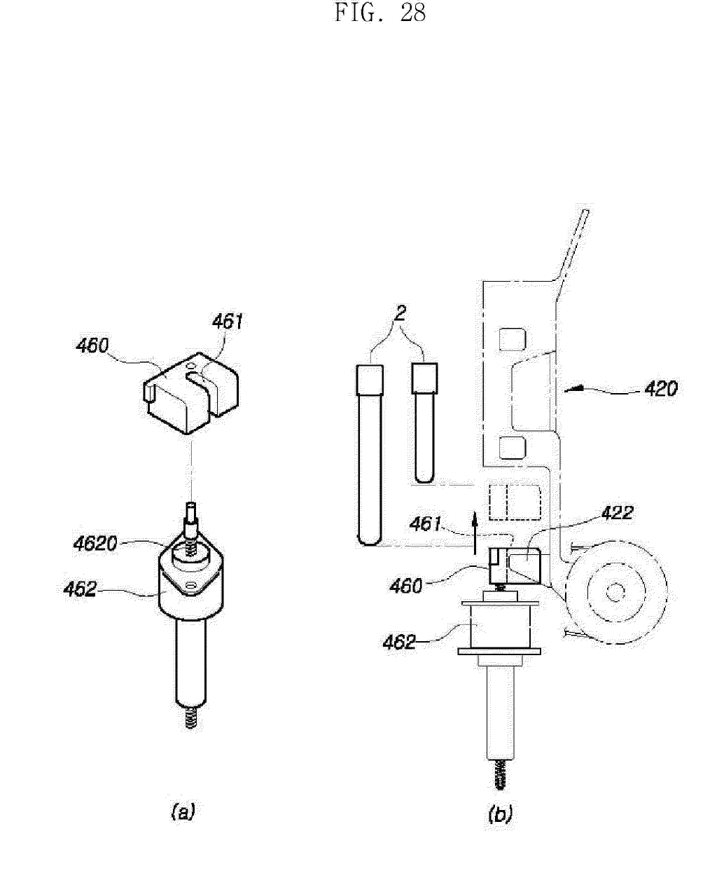

To resolve the problem, the embodiment may include a test tube insertion position adjusting device that can adjust an insertion depth of a test tube 2 that is waiting to be labeled at the first position P1. Referring to FIGS. 26 and 28, in the embodiment, the test tube insertion position adjusting device includes a mobile stopper 460 that is installed on the frame 410 to be movable in the lengthwise direction (insertion direction) of the test tube inserted to the holding member 420 maintaining the first position P1.

The mobile stopper 460 includes a slot 461 passing through the lower stopper 422 so that: the mobile stopper 460 maintains a higher position than the lower stopper 422 of the holding member 460; and the lower stopper 422 moves passing through the mobile stopper 460 and supports the lower end of the test tube 2 when the holding member 420 is rotated from the first position P1 to the second position P2. As the mobile stopper 460 and the holding member 420 are configured in overlapping structure, the embodiment can be designed more compactly.

In addition, the mobile stopper 460 may be made of an elastic material to reduce the impact to the lower end of the test tube 2 inserted into the holding member 420. The mobile stopper 460 may form a concave shape corresponding to the convex shape of the lower end of the test tube 2.

In addition, the embodiment may be equipped with a test tube height sensing sensor (not shown) for detecting a height that the mobile stopper 460 moves up and down and a real position of a test tube to which a label is attached.

The mobile stopper 460 is rotatably coupled to the end of a screw 4620 connected to a lifting motor 462. The mobile stopper 460 moves up or down in the insertion direction of the test tube toward the holding member 420 maintaining the first position P1, cooperating with the screw 4620, according to the forward or reverse rotation of the lifting motor 462.

Therefore, the test tube insertion position adjusting device including the mobile stopper 460 may attach labels to the test tubes 2 inserted into the holding member 420, uniformly, at appropriate height, e.g., the middle position, or at a user's set label positions.

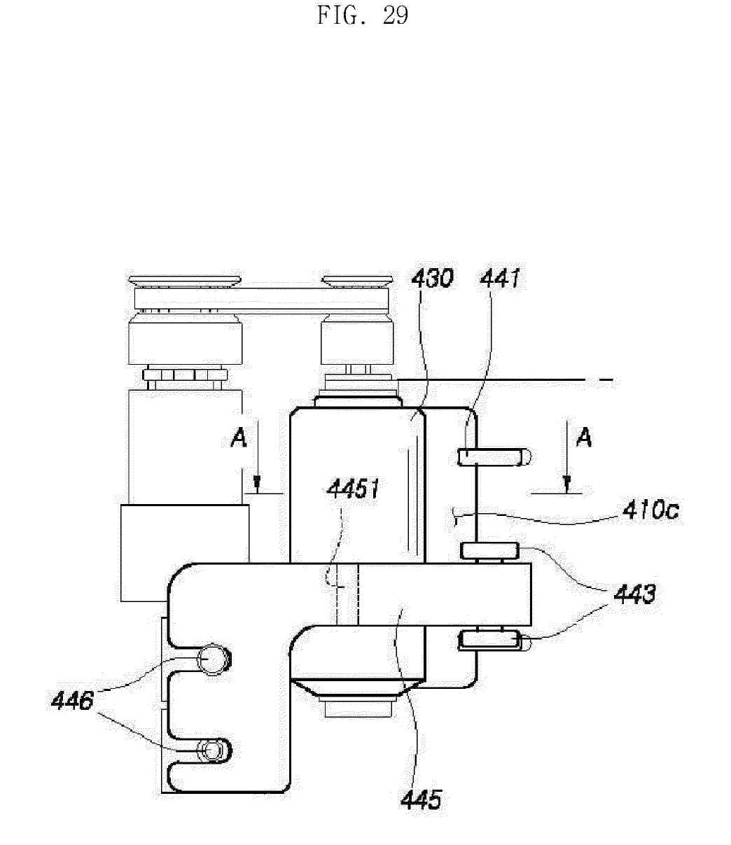

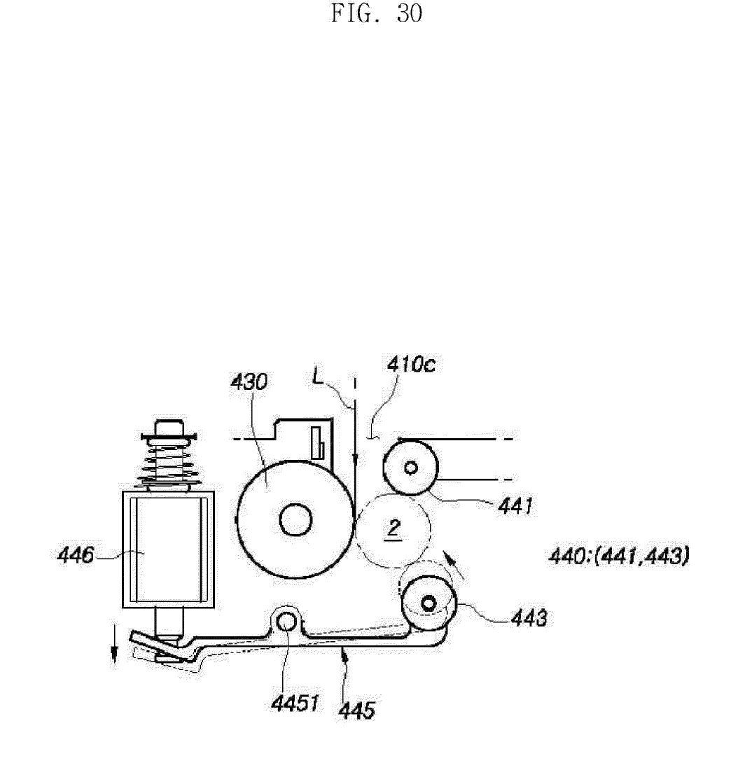

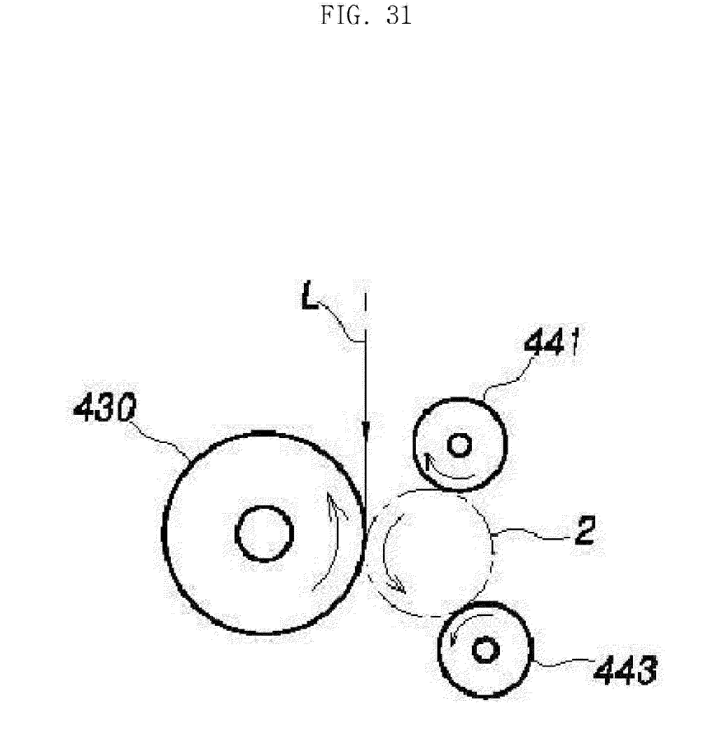

Referring to FIGS. 26, 29, 30 and 31, the drive roller 430 refers to a member that provides a rotational force to attach labels to the introduced test tubes 2. The drive roller 430 is located at one side (or the left side on the figure) around the test tube 2 inserted into the holding member 420 maintaining the first position P1. The drive roller 430 is vertically coupled to the rotation shaft 431 on the labeling frame 410 to maintain a gap from the test tube 2, so that a label L, supplied by a label supply slot 410c of the labeling frame 410, can be inserted between the test tube 2 and the drive roller 430. According the operation of the pressure roller 440 which will be described later, the drive roller 430 contacts the periphery of the test tube inserted into the holding member 420, where label L is between the drive roller 430 and the periphery of the test tube.

Although the embodiment is implemented to include one drive roller 430, it may also be modified to include two or more drive rollers. In addition, in order to prevent the center of rotation of the test tube 2 from being twisted, the embodiment may be equipped with a plurality of drive rollers in the lengthwise direction (insertion direction) of the test tube.

The drive roller 430 may be directly coupled to the output shaft of the rotational motor 432. In the embodiment, the rotational shaft 431 of the drive roller 430 and the output shaft of the rotational motor 432 are coupled to each other by a motive power transmission member of a belt and pulley mode.

Referring to FIGS. 26, 29 and 30, the pressure roller 440 connects the drive roller 430 and the test tube 2 to transmit the rotational force of the drive roller 430 to the test tube 2, and fixedly supports the center of rotation of the test tube 2, along with the drive roller 430. The pressure roller 440 is located approximately opposite the drive roller 430, with respect to the test tube 2 inserted into the holding member 420 maintaining the first position P1. The embodiment may include a plurality of pressure rollers 440 to stably support the periphery of the test tubes 2.

When the embodiment is implemented to include one drive roller 430, it may be equipped with two pressure rollers 440 in order to secure three supporting points on the periphery of the test tube along with the one drive roller 430. That is, one drive roller 430 and two pressure rollers 440 form a triangle structure with respect to the test tube therebetween.

The pressure roller 440 may include one fixed pressure roller 441 and one mobile pressure roller 443.

The fixed pressure roller 441 is rotatably installed to the labeling frame 410. The mobile pressure roller 443 is installed so that it can move close to or apart from the center of rotation of the test tube 2.

In order to satisfy the moving structure of the mobile pressure roller 443, the embodiment includes a pivoting member 445 of which the middle portion is coupled to the frame 410 with the hinge 4451. The pivoting member 445 is configured in such a way that: one end is coupled to the mobile pressure roller 443 so that the end can be rotated about the hinge 4451; and the other end is coupled to the operating cylinder 446.

Therefore, when the operating cylinder 446 is expanded, the pivoting member 445 moves and rotates about the hinge 4451 and thus the mobile pressure roller 443 presses the periphery of the test tube 2 with respect to the center of rotation of the test tube. Therefore, the test tube 2 has three points around the periphery, supported by the drive roller 430, the fixed pressure roller 441 and the mobile pressure roller 443, respectively.

On the contrary, when the operating cylinder 446 is contracted, the pivoting member 445 moves and rotates in the opposite direction about the hinge 4451 and thus the mobile pressure roller 443 is spaced apart from the test tube 2. During this process, the mobile pressure roller 443 needs to be spaced apart from the test tube 2 such a sufficient extent that it does not interfere with the rotation of the holding member 420.

The operating cylinder 446 is preferably implemented with an electronic value (a solenoid valve), a pneumatic cylinder, etc. to prevent the test tube 2 made of a material, such as glass, resin, etc. from being damaged. The operating cylinder 446 may also be implemented with a motor.

In addition, the outer surfaces of the drive roller 430 and the pressure roller 440, tightly contacting the test tube 2, may be formed with an elastic material that can reduce the impact to the test tube 2 or with a material that can reduce the slipping of the test tube 2 that is rotating or can increase the friction.

In addition, as shown in the drawings, in order to prevent the center of rotation of the test tube 2 from being twisted, the embodiment may be equipped with a plurality of pressure rollers 440 in the lengthwise direction (insertion direction) of the test tube.

The following description is provided regarding the operation of the labeling unit 400 configured as described above.

Referring to FIGS. 23, 24, 32, and 33, the test tube 2: is transferred to the guide hole 115 by the gripper 300 and the gripper transfer unit 200; dropped down, passing through the guide hole 115; and introduced to the inside of the holding member 420 maintaining the first position P1, through the upper inflow hole 410a.

The test tube 2 introduced to the holding member 420 is maintained at a certain height in the side stopper 423 as the mobile stopper 460 supports the lower end of the test tube 2. Since the holding member 420 maintaining the first position P1 is inserted into the labeling frame 410, the side opening 4230 is naturally closed by the labeling frame 410, thereby blocking the separation of the test tube 2 through the side opening 4230.

The insertion depth of the test tube 2 into the holding member 420 can be adjusted as the user adjusts the height of the mobile stopper 460.

After that, when the label supplying device 500 supplies a label L between the drive roller 430 and the test tube 2, passing through the label supplying slot 410c of the labeling frame 410, the operating cylinder 446 is operated. When the rod of the operating cylinder 446 is expanded, the pivoting member 445 is rotated about the hinge 4451, and the mobile pressure roller 443 connected to the other end is introduced into the holding member 420 to tightly contact the outer surface of the test tube 2. As the mobile pressure roller 443 continues to move, the test tube 2 is pushed to tightly contact the drive roller 430 and the fixed pressure roller 441 which are arranged opposite the mobile pressure roller 443. Therefore, the test tube 2 is fixedly supported by the drive roller 430, the fixed pressure roller 441 and the mobile pressure roller 443. At this moment, the label L is introduced between the drive roller 430 and the test tube 2.

After that, as the rotational motor 432 operates to rotate the drive roller 430, the test tube 2 is rotated in the direction opposite to the rotation of the drive roller 430 and is affixed with the label L at a speed corresponding to the rotational speed.

The operating cylinder 446 continues to press the mobile pressure roller 443 during the attachment of label L so that the drive roller 430, the fixed pressure roller 441 and the mobile pressure roller 443 can continue to rotate the test tube 2 with a sufficient friction.

When the label attachment is completed, the operation of the rotational motor 432 is ended to stop the rotation of the drive roller 430. The operating cylinder 446 is contracted to separate the mobile pressure roller 443 from the test tube 2.

After that, the swing motor 426 operates to rotate the holding member 420 maintaining the first position P1 with respect to the rotational shaft 425 and move the holding member 420 to the second position P2.

Since the holding member 420 moved to the second position P2 is protruded in the side direction of the labeling frame 410, the side opening 4230 is exposed. The test tube 2 is separated through the side opening 4230 and then discharged in the laid state, toward the tray.

Since the side opening 4230 provided to the holding member 420 is formed to face the side with respect to the rotational direction of the holding member 420, although the test tube 2 is circular in cross section, it is not easy to separate the test tube 2 from the holding member 420 maintaining the second position P2, without any external assistance.

To this end, the labeling frame 410 may be configured to include a pusher 470 at a location corresponding to the second position P2 of the holding member 420 so that the pusher 470 can be inserted into the holding member 420. Since the holding member 420 is rotated to the second position P2 and simultaneously the pusher 470 is inserted into the holding member 420 to press the periphery of the test tube 2, the test tube 2 is enforcedly separated from the side opening 4230 of the holding member 420 and dropped down to the tray t.

As described above, when the test tube 2 is enforcedly separated from the holding member 420 to the outside by the pusher 470, it is preferable to install a tray under the holding member 420 maintaining the second position P2, so that the user can immediately use the labeled test tube 2.

The embodiments of the present invention described in the description and drawings are merely provided to assist in a comprehensive understanding of the invention and are not suggestive of limitation. Although embodiments of the invention have been described in detail above, it should be understood that many variations and modifications of the basic inventive concept herein described, which may be apparent to those skilled in the art, will still fall within the spirit and scope of the embodiments of the invention as defined in the appended claims.

1. A test tube gripper that grips a test tube of which the lower portion is inserted into a hole of a pallet, separates the test tube from the pallet and transfers the test tube, comprising:
a base plate;
a gripper body coupled to the base plate;
a finger fixing block for moving up and down with respect to the gripper body;
an up-and-down operation unit for moving the finger fixing block up and down; and
a finger configured: to be coupled to the finger fixing block; to move up and down cooperating with the finger fixing block; to allow the clampers facing each other to be apart from each other to receive the test tube when moving down; and to allow the clampers facing each other to move close to each other to grip the received test tube when moving up,
wherein: the gripper body is rotated in the front-back direction with respect to the base plate by a front-back direction repulsive force of the test tube created during the gripping and separating processes of the test tube; and the finger is rotated in the left-right direction with respect to the finger fixing block by a left-right direction repulsive force of the test tube created during the gripping and separating processes of the test tube.

2. The test tube gripper of claim 1, wherein:
the gripper body is coupled to be rotated in the front-back direction with respect to the base plate and is configured to rotate about a rotational shaft by the weight and to maintain the vertical position; and
the gripper further comprises:
a first return spring that connects the gripper body and the base plate and presses the gripper body in the front direction to rotate the gripper body about the rotational shaft.

3. The test tube gripper of claim 1, wherein the finger comprises:
a first finger including: a first fixing piece coupled to the finger fixing block; and a first gripping part formed to be extended from the first fixing piece;
a second finger including: a second fixing piece rotatably coupled to the finger fixing block; and a second gripping part formed to be extended from the second fixing piece, facing the first gripping part; and
a second return spring for connecting the first finger and the second finger and pressing the first gripping part and the second gripping part to approach each other.

4. The test tube gripper of claim 3, wherein the gripper body forms a gripping cooperation guide including a slant guide unit that: contacts a protrusion support formed in the second fixing piece and separates the second gripping part from the first gripping part when the first and second fingers are maximally moved down; and moves gradually close the second gripping part to the first gripping part when the first and second fingers move up.

5. The test tube gripper of claim 3, wherein:
the first fixing piece is coupled to rotate and move in the left-right direction from the finger fixing block; and
the first fixing piece coupled to the finger fixing block comprises, on the outer surface, first and second support surfaces for restricting the rotation and movement in the left-right direction of the first finger.

6. The test tube gripper of claim 1, wherein:
the gripper body comprises:
an upper fixing part coupled to the base plate;
a lower fixing part, downward apart from the upper fixing part, for limiting the downward movement of the finger; and
a connection housing coupling the upper fixing part and the lower fixing part to each other and guiding the up-and-down movement of the finger fixing block; and
the gripper further comprises:
a test tube height sensing sensor for sending a height of the test tube that the finger grips and separates from the hole of the pallet.

7. A test tube labeling unit comprising:
a frame with a holding member supporting a test tube introduced to the inside;
a drive roller, arranged at one end around the test tube, for providing a rotational force to the test tube to perform a label attachment; and
a pressure roller, arranged opposite the drive roller, with respect to the test tube, for performing the contact or separation of the test tube to or from the drive roller,
wherein the holding member is rotated in an interval between the first position from which the test tube is introduced to the inside and the second position from which the test tube is discharged to the outside.

8. The test tube labeling unit of claim 7, wherein:
the holding member is rotated from the first position to the second position to be protruded outward from the inside of the frame; and
the holding member comprises:
an upper inflow opening introducing the test tube to the inside;
a lower stopper for supporting the lower end of the test tube; and
a side stopper for coupling the upper inflow opening and the lower stopper to each other, wherein the side stopper forms, at one side, a side opening for allowing the separation of the test tube.

9. The test tube labeling unit of claim 8, wherein:
the frame comprises a pusher inserted into the holding member rotating to the second position (P2); and
the pusher is inserted to the holding member when the holding member is rotated to the second position to push the test tube so that the test tube is separated through the side opening.

10. The test tube labeling unit of claim 7, further comprising:
a test tube insertion depth adjusting device with a mobile stopper for supporting the lower end of the test tube inserted into the holding member.

11. The test tube labeling unit of claim 7, wherein:
the test tube comprises three or more supporting points on the outer surface by one drive roller and two or more pressure rollers;
the pressure roller comprises:
a fixed pressure roller fixedly installed to the frame; and
a mobile pressure roller connected to the frame to move close to or apart from the center of rotation of the test tube; and
the test tube labeling unit comprises a pivoting member of which: the middle portion is coupled to the frame with the hinge; one end is coupled to the mobile pressure roller so that the end can be rotated about the hinge; and the other end is coupled to an operating cylinder.

12. A test tube preparation device comprising:
a frame configure in such a way that: left and right reception units receiving a plurality of test tubes in vertical state are formed on the upper side and one or more guide holes through which the test tubes pass are formed between the left and right reception units;
a gripper transfer unit, installed to the frame, for transferring the test tubes received in the left and right reception units to the guide holes;
a gripper coupled to the gripper transfer unit, for gripping or separating the test tubes; and
a labeling unit, arranged under the guide holes, for attaching labels to the outer surface of the test tubes transferred passing through the guide holes.

13. The test tube preparation device of claim 12, wherein:
the frame is configured in such a way that the upper frame to which the gripper transfer unit is installed and a lower frame which the labeling unit is installed are arranged in layer; and
the test tube preparation device further comprises a loading unit for blocking the guide holes to make the introduced test tubes to be in a waiting state.

14. The test tube preparation device of claim 12, wherein:
the gripper transfer unit comprises:
a left-right transfer unit with a gantry block of which the front-read ends are coupled to move in the left-right direction with respect to the frame;
a front-back transfer unit with a front-back moving block that is coupled to move in the front-back direction with respect to the gantry block; and
a rotation transfer unit with a base plate that is coupled to rotate with respect to the front-back moving block;
the gripper transfer unit transfers the gripper coupled to the base plate in the left-right direction and front-back direction with respect to the left and right reception units, and rotates the gripper to face the left and right reception units; and
the rotation transfer unit reciprocates and rotates between the left and right reception units.

15. The test tube preparation device of claim 12, wherein the device further includes a gripper including:
a base plate;
a gripper body coupled to the base plate;
a finger fixing block for moving up and down with respect to the gripper body;
an up-and-down operation unit for moving the finger fixing block up and down; and
a finger configured to be coupled to the finger fixing block, to move up and down cooperating with the finger fixing block, to allow the clampers facing each other to be apart from each other to receive the test tube when moving down, and to allow the clampers facing each other to move close to each other to grip the received test tube when moving up;
wherein the gripper body is rotated in the front-back direction with respect to the base plate by a front-back direction repulsive force of the test tube created during the gripping and separating processes of the test tube, and the finger is rotated in the left-right direction with respect to the finger fixing block by a left-right direction repulsive force of the test tube created during the gripping and separating processes of the test tube; and
a labeling unit including:
a frame with a holding member supporting a test tube introduced to the inside;
a drive roller, arranged at one end around the test tube, for providing a rotational force to the test tube to perform a label attachment; and
a pressure roller, arranged opposite the drive roller, with respect to the test tube, for performing the contact or separation of the test tube to or from the drive roller,
wherein the holding member is rotated in an interval between the first position from which the test tube is introduced to the inside and the second position from which the test tube is discharged to the outside.

16. The test tube preparation device of claim 12, and including
a labeling unit, the labeling unit including:
a frame with a holding member supporting a test tube introduced to the inside;
a drive roller, arranged at one end around the test tube, for providing a rotational force to the test tube to perform a label attachment; and
a pressure roller, arranged opposite the drive roller, with respect to the test tube, for performing the contact or separation of the test tube to or from the drive roller,
wherein the holding member is rotated in an interval between the first position from which the test tube is introduced to the inside and the second position from which the test tube is discharged to the outside.
